(19) United States
(12) Patent Application Publication
(10) Pub. No.: US 2026/0005714 A1
(43) Pub. Date: Jan. 1, 2026

(54) AXIAL RATIO COMPENSATION METHOD FOR ANTENNA ARRAY

(71) Applicant: TRON FUTURE TECH INC., HSINCHU CITY (TW)

(72) Inventors: SHIH-KAI LIN, HSINCHU CITY (TW); YUNG-CHANG HSU, HSINCHU CITY (TW)

(21) Appl. No.: 19/253,707

(22) Filed: Jun. 27, 2025

Related U.S. Application Data
(60) Provisional application No. 63/665,257, filed on Jun. 28, 2024.

(51) Int. Cl. H04B 1/12; H04B 1/04; H04B 7/0426

(52) U.S. Cl. CPC H04B 1/12; H04B 1/04; H04B 7/043; H04B 2001/0416

(57) ABSTRACT

An axial ratio compensation method performed by an antenna system including an antenna array having antenna elements is provided. The axial ratio compensation method includes: receiving, by the antenna array, a first linearly polarized beam from a predetermined direction by enabling respective first ports of the antenna elements, so that the antenna array generates a first radio frequency (RF) signal; receiving, by the antenna array, a second linearly polarized beam from the predetermined direction by enabling respective second ports of the antenna elements, so that the antenna array generates a second RF signal, wherein the first linearly polarized beam and the second linearly polarized beam are substantially orthogonal; and compensating at least one of a phase difference and a magnitude difference between the first RF signal and the second RF signal to compensate an axial ratio of the antenna array at the predetermined direction.

### PRIORITY CLAIM AND CROSS-REFERENCE

The present application claims priority to U.S. Provisional Patent Application Ser. No. 63/665,257, filed on Jun. 28, 2024, which is incorporated by reference herein in its entirety.

### BACKGROUND

The present disclosure relates to antenna arrays, more particularly, to an axial ratio compensation method for antenna array beamforming.

Beyond 5G (B5G) represents a transformative leap in wireless communication, delivering ultra-high data rates, low latency, and massive connectivity to support advanced applications like autonomous vehicles, smart cities, immersive virtual reality, industrial automation, and high-resolution radar systems. Phased array antennas are a cornerstone of B5G, offering beamforming, adaptive beam steering, and enhanced spatial resolution to optimize communication and sensing. For example, phased arrays implemented using circularly polarized antennas not only improve signal reliability in multipath environments, but also enhance polarization matching and mitigate signal degradation caused by device misalignment. These capabilities make circularly polarized antennas vital for diverse B5G applications, including satellite-ground integration, mobile networks, and seamless operation in complex or dynamic environments, ensuring robust performance and efficient resource utilization.

### SUMMARY

The described embodiments provide an axial ratio compensation method for antenna array beamforming.

One aspect of the present disclosure provides an axial ratio compensation method performed by an antenna system including an antenna array having antenna elements. The axial ratio compensation method includes the following steps: receiving, by the antenna array, a first linearly polarized beam from a predetermined direction by enabling respective first ports of the antenna elements, so that the antenna array generates a first radio frequency (RF) signal; receiving, by the antenna array, a second linearly polarized beam from the predetermined direction by enabling respective second ports of the antenna elements, so that the antenna array generates a second RF signal; and compensating at least one of a phase difference and a magnitude difference between the first RF signal and the second RF signal to compensate an axial ratio of the antenna array at the predetermined direction. The first linearly polarized beam and the second linearly polarized beam are substantially orthogonal.

One aspect of the present disclosure provides an axial ratio compensation method performed by an antenna system including an antenna array having antenna elements. The axial ratio compensation includes the following steps: controlling the antenna array to receive a first polarized beam from a predetermined direction according to first beamforming information, so that the antenna array generates a first RF signal; controlling the antenna array to receive a second polarized beam from the predetermined direction according to second beamforming information, so that the antenna array generates a second RF signal; and compensating at least one of a phase difference and a magnitude difference between the first RF signal and the second RF signal to compensate an axial ratio of the antenna array at the predetermined direction. The first polarized beam and the second polarized beam have different polarization types.

The proposed axial ratio compensation scheme can decompose circular polarization into two linear polarization modes to thereby analyze circular polarization characteristics. In each of the linear polarization mode, the proposed axial ratio compensation scheme can perform beamforming and at least one of magnitude compensation and phase compensation. Subsequently, the proposed axial ratio compensation scheme can achieve axial ratio compensation in the beamforming process of a circularly polarized antenna array by adjust at least one of a magnitude difference and a phase difference between two antenna input ports configured for two polarization directions, in which the phase difference is generated when the two antenna input ports are in an activated state concurrently. The proposed axial ratio compensation scheme not only can achieve excellent circular polarization characteristics, but also can offer high levels of intuitiveness and logical clarity.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram illustrating a subarray included in an antenna array in accordance with some embodiments of the present disclosure.

FIG. 2A is a diagram illustrating at least a portion of an antenna array, implemented using the subarray structure shown in FIG. 1, in accordance with some embodiments of the present disclosure.

FIG. 2B is a diagram illustrating the operation of the antenna array shown in FIG. 2A, which utilizes sequential rotation during beamforming to improve polarization characteristics, in accordance with some embodiments of the present disclosure.

FIG. 3 is a flow chart of an exemplary axial ratio compensation method for an antenna array in accordance with some embodiments of the present disclosure.

FIG. 4 is a diagram illustrating an antenna system in accordance with some embodiments of the present disclosure.

FIG. 5 illustrates an implementation of the axial ratio compensation method shown in FIG. 3 in accordance with some embodiments of the present disclosure.

FIG. 6A is an implementation of the antenna array shown in FIG. 4 employing the axial ratio compensation method shown in FIG. 5 to operate in a first polarization mode in accordance with some embodiments of the present disclosure.

FIG. 6B is an implementation of the antenna array shown in FIG. 4 employing the axial ratio compensation method shown in FIG. 5 to operate in a second polarization mode in accordance with some embodiments of the present disclosure.

FIG. 7 is a diagram illustrating the operations and phase information involved when the subarray shown in FIG. 4 performs a step of the axial ratio compensation method shown in FIG. 5 in accordance with some embodiments of the present disclosure.

FIG. 8 is a diagram illustrating the operations and phase information involved when the subarray shown in FIG. 4 performs a step of the axial ratio compensation method shown in FIG. 5 in accordance with some embodiments of the present disclosure.

FIG. 9 is a diagram illustrating the operations and phase information involved when the subarray shown in FIG. 4 performs a step of the axial ratio compensation method shown in FIG. 5 in accordance with some embodiments of the present disclosure.

FIG. 10 is a diagram illustrating the operations and phase information involved when the subarray shown in FIG. 4 performs a step of the axial ratio compensation method shown in FIG. 5 in accordance with some embodiments of the present disclosure.

FIG. 11 is a diagram illustrating the operations and phase information involved when the subarray shown in FIG. 4 performs a process of the axial ratio compensation method shown in FIG. 5 in accordance with some embodiments of the present disclosure.

FIG. 12 illustrates an implementation of the axial ratio compensation method shown in FIG. 3 in accordance with some embodiments of the present disclosure.

FIG. 13 illustrates another implementation of the axial ratio compensation method shown in FIG. 3 in accordance with some embodiments of the present disclosure.

FIG. 14 is a flow chart of an exemplary axial ratio compensation method for an antenna array in accordance with some embodiments of the present disclosure.

FIG. 15 is a diagram illustrating an antenna system in accordance with some embodiments of the present disclosure.

FIG. 16 is a diagram illustrating the integrated circuit of FIG. 15 in accordance with some embodiments of the present disclosure.

FIG. 17A is an implementation of the integrated circuit shown in FIG. 16 employing the axial ratio compensation method shown in FIG. 14 to operate in a first polarization mode in accordance with some embodiments of the present disclosure.

FIG. 17B is an implementation of the integrated circuit shown in FIG. 16 employing the axial ratio compensation method shown in FIG. 14 to operate in a second polarization mode in accordance with some embodiments of the present disclosure.

FIG. 18 illustrates an implementation of the axial ratio compensation method shown in FIG. 14 in accordance with some embodiments of the present disclosure.

FIG. 19 illustrates an implementation of the axial ratio compensation method shown in FIG. 14 in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the present disclosure may repeat reference numerals and/or letters in the various examples. This repetition is for the purpose of simplicity and clarity and does not in itself dictate a relationship between the various embodiments and/or configurations discussed.

Further, it will be understood that when an element is referred to as being “connected to” or “coupled to” another element, it may be directly connected to or coupled to the other element, or intervening elements may be present.

Moreover, spatially relative terms, such as “below,” “above,” “left,” “right,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In a phased array antenna system, the axial ratio (AR) is a critical indicator for evaluating the polarization purity of a circularly polarized (CP) antenna. However, the axial ratio may deviate due to various factors such as mutual coupling between antennas, manufacturing tolerances, and variations in scan angles. Such deviations can result in polarization mismatch, thereby degrading signal transmission efficiency and reliability. Accordingly, in antenna applications such as B5G, satellite communications, and radar systems, axial ratio compensation is an essential technique for maintaining stable polarization characteristics, which can contribute to enhanced signal stability and interference immunity.

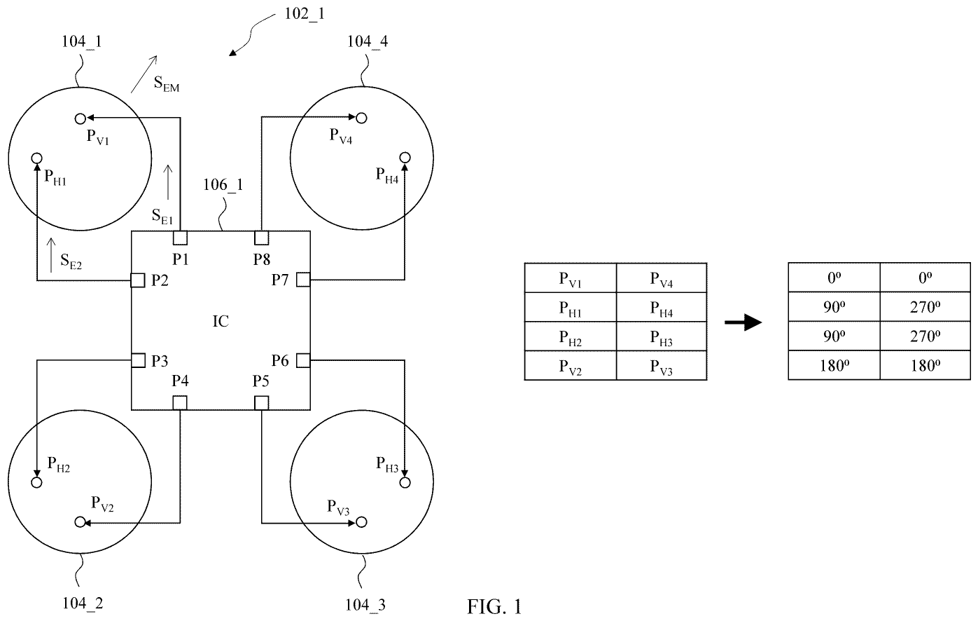

FIG. 1 is a diagram illustrating a subarray included in an antenna array in accordance with some embodiments of the present disclosure. The subarray 102_1 may include, but is not limited to, antenna elements 104_1 to 104_4 and an integrated circuit (IC) 106_1 (or a chip). The antenna elements 104_1 to 104_4 may be controlled by the single integrated circuit 106_1. In some embodiments where the subarray 102_1 is implemented as at least part of a circularly polarized antenna array, the integrated circuit 106_1 can be configured to transmit electrical signals from the ports (or referred to as output ports) P1 to P8 to the antenna elements 104_1 to 104_4, thereby exciting each antenna element to generate a circularly polarized wave. For example, the integrated circuit 106_1 is configured to output the electrical signals S_{E1} and S_{E2} from the ports P1 and P2 to the ports (or referred to as feed ports) P_{V1} and P_{H1} of the antenna element 104_1, respectively, thereby exciting the antenna element 104_1 to generate an electromagnetic signal SEM. The port P_{V1} may correspond to a vertical polarization component of the electromagnetic signal SEM, and can be referred to as a vertical polarization port. The port P_{H1} may correspond to a horizontal polarization component of the electromagnetic signal SEM, and can be referred to as a horizontal polarization port. The antenna element 104_1 may generate a left-hand or right-hand circularly polarized wave (i.e., the electromagnetic signal SEM) according to the electrical signals S_{E1} and S_{E2}, which are equal in amplitude and differ in phase by 90°. In the present embodiment, each of the antenna elements 104_2 to 104_4 can include a port that corresponds to a vertical polarization component (e.g., the port P_{V2}/P_{V3}/P_{V4}) and another port that corresponds to a horizontal polarization component (e.g., the port P_{H2}/P_{H3}/P_{H4}).

In a case where the characteristics of the antenna elements 104_1 to 104_4 vary, or one or more of the antenna elements 104_1 to 104_4 exhibits insufficient circular polarization performance, the overall circular polarization performance of the subarray 102_1 (or the entire antenna array) may degrade, resulting in a non-ideal axial ratio or a deviation of beam steering from the target direction. To ensure that the far-field radiation patterns of antenna elements 104_1 to 104_4 are properly superimposed (i.e., having the same polarization direction and phase) to thereby maintain good circular polarization characteristics, the antenna array may employ a sequential rotation design. In the present embodiment, each antenna element is sequentially rotated by a fixed angle (e.g., 90°) relative to the center of subarray 102_1. Furthermore, the integrated circuit 106_1 may output electrical signals with phases of 0°, 90°, 90°, 180°, 0°, 270°, 270°, and 180° from the ports P1 to P8, respectively, based on (but not limited to) a phase table as shown on the right side of FIG. 1. The electrical signals are used to control the phases and magnitude applied to the ports P_{V1}, P_{H1}, P_{H2}, P_{V2}, P_{V3}, P_{H3}, P_{H4} and P_{V4}, thereby improving the circular polarization characteristics of the antenna array. In other words, compared to a single antenna element, the subarray 102_1 exhibits superior circular polarization performance when viewed from directly above the subarray 102_1 (e.g., along the normal direction of the subarray 102_1).

However, the sequential rotation design is generally more beneficial for radiation in the direction perpendicular to the antenna array (e.g., the normal direction). When the antenna array is used for wide-angle beam steering, it becomes difficult to maintain good axial ratio characteristics. Therefore, further compensation of the axial ratio is typically required under such conditions.

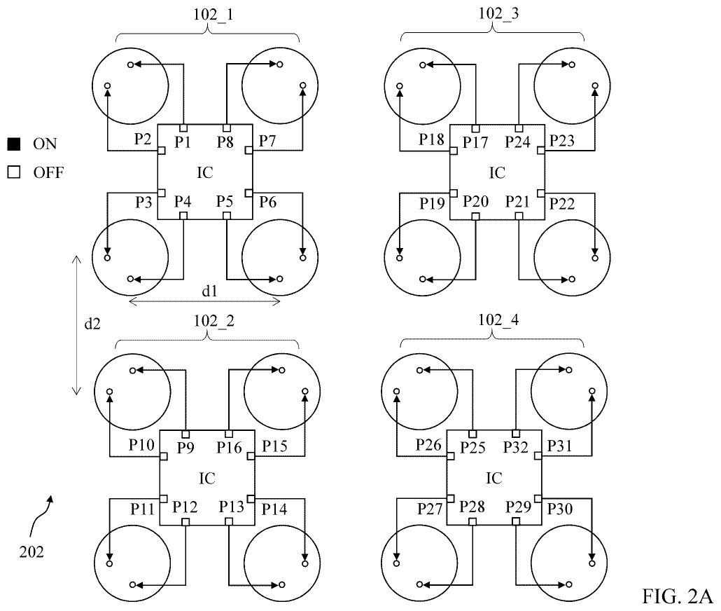

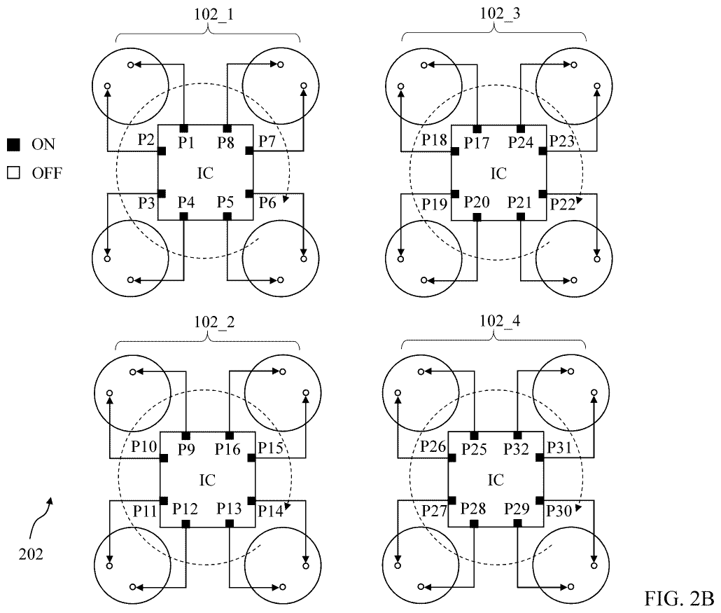

FIG. 2A is a diagram illustrating at least a portion of an antenna array, implemented using the subarray structure shown in FIG. 1, in accordance with some embodiments of the present disclosure. In the present embodiment, the antenna array 202 includes the subarray 102_1 shown in FIG. 1, and the subarrays 102_2 to 102_4. Each of the subarrays 102_2 to 102_4 may have a structure and operation substantially identical to those of the subarray 102_1. The distance d1 between adjacent antenna elements within the same subarray may be equal to or substantially equal to half the wavelength of the electromagnetic wave emitted by the antenna array 202, but this disclosure is not limited thereto. The distance d2 between adjacent antenna elements located in different subarrays may also be equal to or substantially equal to half the wavelength of the emitted electromagnetic wave transmitted by the antenna array 202, but this disclosure is not limited thereto. In the embodiment shown in FIG. 2A, the ports P1 to P32 are in an OFF state (i.e., not activated), as indicated by white rectangles. For example, the integrated circuits 106_1 to 106_4 have not yet provided electrical signals (e.g., excitation signals) to antenna feed ports via the corresponding ports thereof.

FIG. 2B is a diagram illustrating the operation of the antenna array 202 shown in FIG. 2A, which utilizes sequential rotation during beamforming to improve polarization characteristics, in accordance with some embodiments of the present disclosure. Referring to FIG. 2B, the antenna array 202 may activate (or enable) the ports of each integrated circuit (i.e., the ports P1 to P32) concurrently, in which each activated port (i.e., a port in an ON state) is indicated by a black rectangle. In addition, a phase difference between two feed ports of each antenna element may be 90°, which results in circular polarization when observed from directly above the antenna array 202. To improve circular polarization performance in the boresight direction, the antenna array 202 may further apply a corresponding sequential rotation phase to each port. By way of example but not limitation, phase compensations of 0°, 90°, 90°, 180°, 0°, 270°, 270° and 180° may be applied to the ports P1 to P8, respectively; The same phase compensation sequence is reused across the ports P9 to P16, the ports P17 to P24, and the ports P25 to P32. Additionally, the antenna array 202 may apply a delay phase to each antenna element to perform beamforming toward a target angle.

Next, the cross polarization discrimination (XPD) (a power difference between the received left-hand circularly polarized (LHCP) signal and right-hand circularly polarized (RHCP) signal) at a target beamforming angle may be evaluated according to the circular polarization beam measurement results of the antenna array 202, thereby estimating the axial ratio. If the axial ratio does not fall within a target range, a trial-and-error method may be employed, in which each integrated circuit adjusts the amplitude and phase of its output ports to improve the axial ratio. However, the trial-and-error method may result in an excessively long axial ratio compensation process.

The present disclosure describes exemplary axial ratio compensation methods for antenna arrays, each of which perform axial ratio compensation for circularly polarized antenna arrays during beamforming by decomposing circular polarization into two linear polarization modes for analysis. For example, the exemplary axial ratio compensation method may firstly perform phase aligning and beamforming when the two linear polarization modes are enabled individually, and then perform compensation to at least one of the magnitude difference and phase difference between the two linear polarization modes, thereby improving the axial ratio. In some embodiments, the exemplary axial ratio compensation method can compensate the phase difference between the two linear polarization electric field components. In addition, the exemplary axial ratio compensation method can compensate the magnitude of the two linear polarization electric field components prior to or after compensating their phase difference. Compared to a trial-and-error based compensation approach, the proposed axial ratio compensation scheme is more intuitive and logically structured. Further description is provided below.

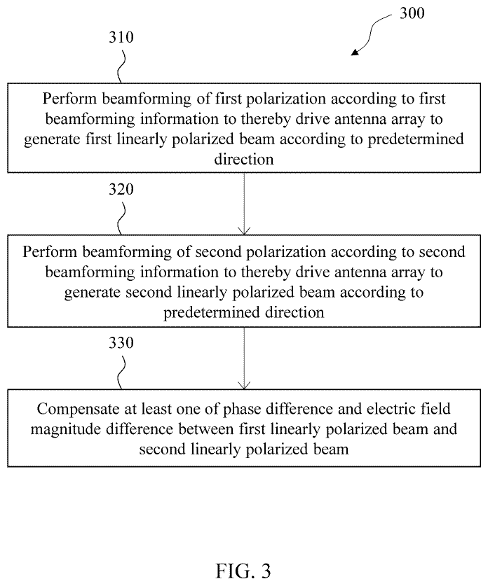

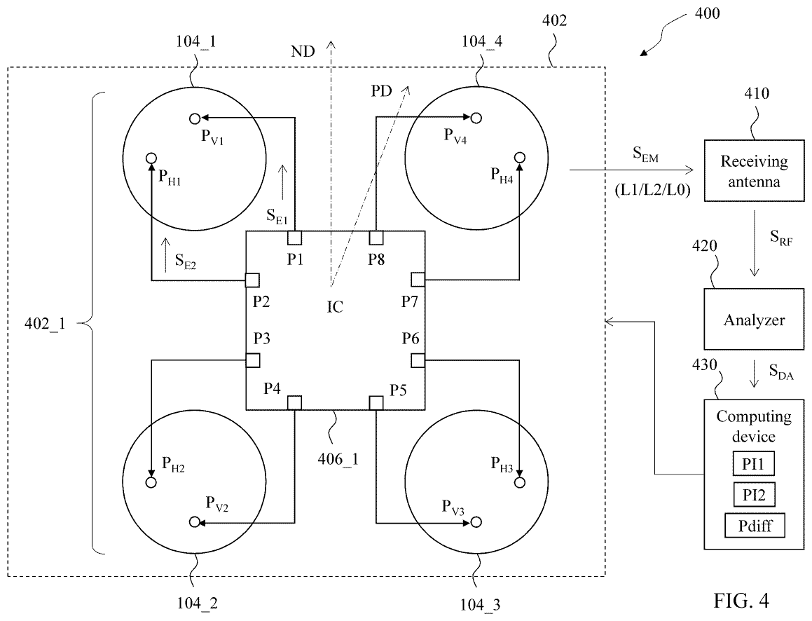

FIG. 3 is a flow chart of an exemplary axial ratio compensation method for an antenna array in accordance with some embodiments of the present disclosure. For illustrative purposes, the axial ratio compensation method 300 is described below with reference to the antenna system 400 shown in FIG. 4. The antenna system 400 shown in FIG. 4 may include, but is not limited to, an antenna array 402, a receiving antenna 410, an analyzer 420, and a computing device 430. The antenna array 402 includes a subarray 402_1. The structure of the subarray 402_1 is substantially identical/similar to that of the subarray 102_1 shown in FIG. 1 except that the integrated circuit 406_1 of the subarray 402_1 can be configured to perform the axial ratio compensation method 300 shown in FIG. 3. Those skilled in the art will recognize that the axial ratio compensation method 300 can be applied to other antenna elements/arrays having antenna input ports (or antenna feed ports) that corresponds to different polarizations without departing from the scope of the present disclosure. Additionally, in some embodiments, other operations can be performed in the axial ratio compensation method 300. In some embodiments, operations of the axial ratio compensation method 300 can be performed in a different order and/or vary.

Referring to FIG. 3 and FIG. 4, in step 310, beamforming of first polarization (e.g., vertical polarization) is performed according to first beamforming information PI1 to thereby driving the antenna array to generate a first linearly polarized beam L1 according to a predetermined direction/angle. The first linearly polarized beam L1 can be the main lobe of the electromagnetic signal SEM when the antenna array is driven to perform beamforming of first polarization. For example, the antenna array may be driven so that the first linearly polarized beam L1 (e.g., the main lobe) or a predetermined side lobe of the first linearly polarized beam L1 is directed toward the predetermined direction. The first beamforming information PI1 may indicate phases that are applied to antenna elements of the antenna array when the antenna array generates the first linearly polarized beam L1 according to the predetermined direction/angle, where the first beamforming information PI1 may be stored in the computing device 430. In the present embodiment, the integrated circuit 406_1 may perform beamforming according to the first beamforming information PI1 to thereby drive the antenna array 402 to generate a first linearly polarized beam L1 directed toward a predetermined direction PD. The predetermined direction PD forms a predetermined angle (e.g., 60°) with the normal direction ND of the antenna array 402.

By way of example but not limitation, a direction of the first linearly polarized beam L1 or a direction of the predetermined side lobe thereof can be calibrated. Calibration of the direction of the first linearly polarized beam L1 is explained below. The receiving antenna 410 may receive the electromagnetic signal SEM transmitted by the antenna array 402, and accordingly generate a radio frequency (RF) signal S_{RF}. The analyzer 420 (e.g. a network analyzer or a vector network analyzer (VNA)) can generate the analysis data S_{DA} according to the RF signal S_{RF}. The computing device 430 receives the analysis data S_{DA}, and controls the integrated circuit 406_1 according to the first beamforming information PI1 and the analysis data S_{DA}. Therefore, the integrated circuit 406_1 can generate electrical signals provided for each vertical feed ports P_{V1} to P_{V4} (e.g., the electrical signal SEI to the vertical feed port P_{V1}) according to the first beamforming information PI1 and the analysis data S_{DA}, such that the direction of the first linearly polarized beam L1 (e.g., the direction of maximum radiation) can match, approximate or gradually approach the predetermined direction PD indicated by the first beamforming information PI1.

In step 320, beamforming of second polarization (e.g., horizontal polarization) is performed according to second beamforming information PI2 to thereby driving the antenna array to generate a second linearly polarized beam L2 according to the predetermined direction/angle. The second linearly polarized beam L1 can be the main lobe of the electromagnetic signal SEM when the antenna array is driven to perform beamforming of second polarization. For example, the antenna array may be driven so that the second linearly polarized beam L2 (e.g., the main lobe) or a predetermined side lobe of the second linearly polarized beam L2 is directed toward the predetermined direction. The second beamforming PI2 information may indicate phases that are applied to the antenna elements when the antenna array generates the second linearly polarized beam L2 according to the predetermined direction/angle, where the second beamforming information PI2 may be stored in the computing device 430. The first linearly polarized beam L1 and the second linearly polarized beam L2 have different polarization directions. For example, the first linearly polarized beam L1 can be substantially orthogonal to the second linearly polarized beam L2. In the present embodiment, the integrated circuit 406_1 may perform beamforming according to the second beamforming information PI2 to thereby drive the antenna array 402 to generate a second linearly polarized beam L2 directed toward the predetermined direction PD.

By way of example but not limitation, a direction of the second polarized beam L2 or a direction of the predetermined side lobe thereof can be calibrated. Calibration of the direction of the second linearly polarized beam L2 is explained below. The receiving antenna 410 may receive the electromagnetic signal SEM transmitted by the antenna array 402, and accordingly generate the RF signal S_{RF}. The analyzer 420 can generate the analysis data S_{DA} according to the RF signal S_{RF}. The computing device 430 receives the analysis data S_{DA}, and controls the integrated circuit 406_1 according to the second beamforming information PI2 and the analysis data S_{DA}. Therefore the integrated circuit 406_1 can generate electrical signals provided for each horizontal feed ports P_{H1} to P_{H4} (e.g., the electrical signal S_{E2} to the horizontal feed port P_{H1}) according to the second beamforming information PI2 and the analysis data S_{DA}, such that the direction of the second linearly polarized beam L2 (e.g., the direction of maximum radiation) can match, approximate or gradually approach the phases indicated by the second beamforming information PI2.

By way of example but not limitation, the ports P_{V1}, P_{V2}, P_{V3} and P_{V4} can be configured to excite the first linearly polarized beam L1, while the ports P_{H1}, P_{H2}, P_{H3} and P_{H4} can be configured to excite the second linearly polarized beam L2. When the ports P_{V1} to P_{V4} are excited (or in an activated/ON state), the respective phases of the ports P_{V1} to P_{V4} can be controlled, by the computing device 430, according to the first beamforming information PI1 to thereby perform beamforming of first linearly polarized beam L1 (step 310). The first beamforming information PI1 is configured to drive the antenna array 402 to generate the first linearly polarized beam L1; alternatively stated, the first beamforming information PI1 can indicate phases that are applied to the ports P_{V1} to P_{V4} for driving the antenna array 402 to generate the first linearly polarized beam L1. In some embodiments, when performing step 310, the ports P_{H1} to P_{H4} may be unexcited (or in a deactivated/OFF state).

In addition, when the ports P_{H1} to P_{H4} are excited (or in an activated/ON state), the respective phases of the ports P_{H1} to P_{H4} can be controlled, by the computing device 430, according to the second beamforming information PI2 to thereby perform beamforming of horizontal polarized beam L2 (step 320). The second beamforming information PI2 is configured to drive the antenna array 402 to generate the second linearly polarized beam L2; alternatively stated, the second beamforming information PI2 can indicate phases that are applied to the ports P_{H1} to P_{H4} for driving the antenna array 402 to generate the second linearly polarized beam L2. In some embodiments, when performing step 320, the ports P_{V1} to P_{V4} may be unexcited (or in a deactivated/OFF state).

Accordingly, the ports P_{V1}, P_{V2}, P_{V3} and P_{V4} can be configured for a first polarization (e.g., a vertical polarization), while the ports P_{H1}, P_{H2}, P_{H3} and P_{H4} can be configured for a second polarization orthogonal to the first polarization (e.g., a horizontal polarization). When the ports P_{V1} to P_{V4} are excited (or in an activated/ON state), the antenna array 402 can be driven to generate the first linearly polarized beam L1 by applying the first beamforming information PI1 to the ports P_{V1} to P_{V4} to perform beamforming of first polarization (step 310). In addition, when the ports P_{H1} to P_{H4} are excited (or in an activated/ON state), the antenna array 402 can be driven to generate the second linearly polarized beam L2 by applying the second beamforming information PI2 to the ports P_{H1} to P_{H4} to perform beamforming of second polarization beam (step 320). It is noted that step 310 and step 320 can be performed in a different order. For example, step 310 may be performed after step 320. As another example, all of the ports P_{V1} to P_{V4} and ports P_{H1} to P_{H4} may be excited (or in an activated/ON state) so that step 310 and step 320 can be performed concurrently.

Although the first linearly polarized beam L1 and the second linearly polarized beam L2 both are directed toward the predetermined direction PD, the superimposed beam formed by the first linearly polarized beam L1 and the second linearly polarized beam L2 may have poor circular polarization characteristics (e.g., the axial ratio). Therefore, in step 330, an axial ratio compensation is performed to the first linearly polarized beam L1 and the second linearly polarized beam L2. The axial ratio compensation includes at least one of phase compensation and electric field magnitude compensation.

Phase compensation is performed according to the phase difference information Pdiff stored in the computing device 430. The phase difference information Pdiff may indicate a predetermined phase difference approximate or equal to 90°, but this disclosure is not limited thereto. The phase compensation is intended to make the first linearly polarized beam L1 and the second linearly polarized beam L2 to have the predetermined phase difference. The phase difference between the first linearly polarized beam L1 and the second linearly polarized beam L2 may be determined by the analyzer 420 through the RF signal S_{RF}. The analyzer 420 may generate the analysis data S_{DA} according to the RF signal S_{RF}, where the analysis data S_{DA} includes the phase difference between the first linearly polarized beam L1 and the second linearly polarized beam L2. According to the analysis data S_{DA} and the predetermined phase difference indicated by the phase difference information Pdiff, the computing device 430 can control the integrated circuit 406_1 to adjust the phase of either the first ports (e.g., ports P_{V1} to P_{V4}) or the second ports (e.g., ports P_{H1} to P_{H4}) while remaining the phase of the other to be fixed, until the first linearly polarized beam L1 and the second linearly polarized beam L2 have the predetermined phase difference. The first port and the second port of each antenna element can be configured to excite the first linearly polarized beam and the second linearly polarized beam, respectively, and the first polarization is orthogonal to the second polarization. That is, the integrated circuit 406_1 may keep the phase of one of the first linearly polarized beam L1 and the second linearly polarized beam L2 to be fixed as the reference, while compensating the phase of the other; however, the present disclosure is not limited thereto. In some embodiments, the phases of both the first ports (e.g., ports P_{V1} to P_{V4}) and the second ports (e.g., ports P_{H1} to P_{H4}) are adjusted.

The electric field magnitude compensation is intended to compensate the electric field magnitude difference between the electric fields of the first linearly polarized beam L1 and the second linearly polarized beam L2. The electric field magnitude difference between the first linearly polarized beam L1 and the second linearly polarized beam L2 may be determined by the analyzer 420 through the RF signal S_{RF}. The analyzer 420 may generate the analysis data S_{DA} according to the RF signal S_{RF}, where the analysis data S_{DA} includes the electric field magnitude difference between the first linearly polarized beam L1 and the second linearly polarized beam L2. According to the analysis data S_{DA}, the computing device 430 can control the integrated circuit 406_1 to adjust the signal strength (e.g., signal amplitude) of either the first ports (e.g., ports P_{V1} to P_{V4}) or the second ports (e.g., ports P_{H1} to P_{H4}) while remaining the signal strength of the other to be fixed. That is, the integrated circuit 406_1 may keep the electric field magnitude of one of the first linearly polarized beam L1 and the second linearly polarized beam L2 to be fixed as the reference while compensating the electric field magnitude of the other; however, the present disclosure is not limited thereto. In some embodiments, the signal strength of both the first ports (e.g., ports P_{V1} to P_{V4}) and the second ports (e.g., ports P_{H1} to P_{H4}) are adjusted. When the axial ratio compensation is finished, the antenna array 402 can excite the ports P_{V1} to P_{V4} and P_{H1} to P_{H4} to generate the electromagnetic signal SEM formed by the compensated first linearly polarized beam L1 and the compensated second linearly polarized beam L2. Under this situation, the electromagnetic signal SEM becomes a predetermined circularly polarized beam L0 directed toward the predetermined direction PD, which has an improved axial ratio (e.g., less than 3 dB).

By way of example but not limitation, the integrated circuit 406_1 may drive the antenna elements 104_1 to 104_4 to emit the electromagnetic signal SEM according to the first beamforming information PI1 and the second beamforming information PI2 to generate the first linearly polarized beam L1 and the second linearly polarized beam L2. The receiving antenna 410 may receive the electromagnetic signal SEM (the first linearly polarized beam L1 or the second linearly polarized beam L2) and accordingly generate the RF signal S_{RF}. The analyzer 420 may generate the analysis data S_{DA} according to the RF signal S_{RF}. The analyzer 420 may determine the phase difference and/or electric field magnitude difference between the first linearly polarized beam L1 and the second linearly polarized beam L2 to generate the analysis data S_{DA}. The computing device 430 may control the integrated circuit 406_1 to compensate the phase difference and/or electric field magnitude difference between the first linearly polarized beam L1 and the second linearly polarized beam L2, according to the analysis data S_{DA} and the predetermined phase difference indicated by the phase difference information Pdiff. For example, the integrated circuit 406_1 may perform phase compensation by adjusting the phase difference between the first linearly polarized beam L1 and the second linearly polarized beam L2 to match or approach the predetermined phase difference. In some cases where the predetermined phase difference indicated by the phase difference information Pdiff is 90°, the compensated electromagnetic signal SEM (i.e., the predetermined circularly polarized beam L0) may have good circular polarization characteristics, such as an improved axial ratio.

Note that the architecture of the antenna system 400 described above is provided for illustrative purposes, and is not intended to limit the scope of the present disclosure. In some embodiments, the antenna system 400 includes multiple subarrays, each having a substantially identical structure. In some embodiments, the integrated circuit 406_1 may obtain signal information on the electromagnetic signal SEM emitted by the antenna array 402 via other signal transmission structures/paths.

By performing beamforming independently in two different polarization modes/directions (e.g., two orthogonal polarization directions), and subsequently adjusting the phase difference and/or electric field magnitude compensation between two linearly polarized beams when the antenna input ports of both vertical and horizontal polarizations are excited, the proposed axial ratio compensation scheme can provide axial ratio compensation for circularly polarized antenna arrays, thereby achieving enhanced circular polarization performance.

To facilitate understanding of the present disclosure, some embodiments are provided below to further describe the proposed axial ratio compensation scheme. However, this is not intended to limit the scope of the present disclosure. Those skilled in the art will appreciate that other antenna systems or antenna compensation processes employing beamforming in different polarization directions (or polarization modes), followed by adjustment of the phase difference and/or electric field magnitude compensation between the two linearly polarized beams, also fall within the scope of the present disclosure.

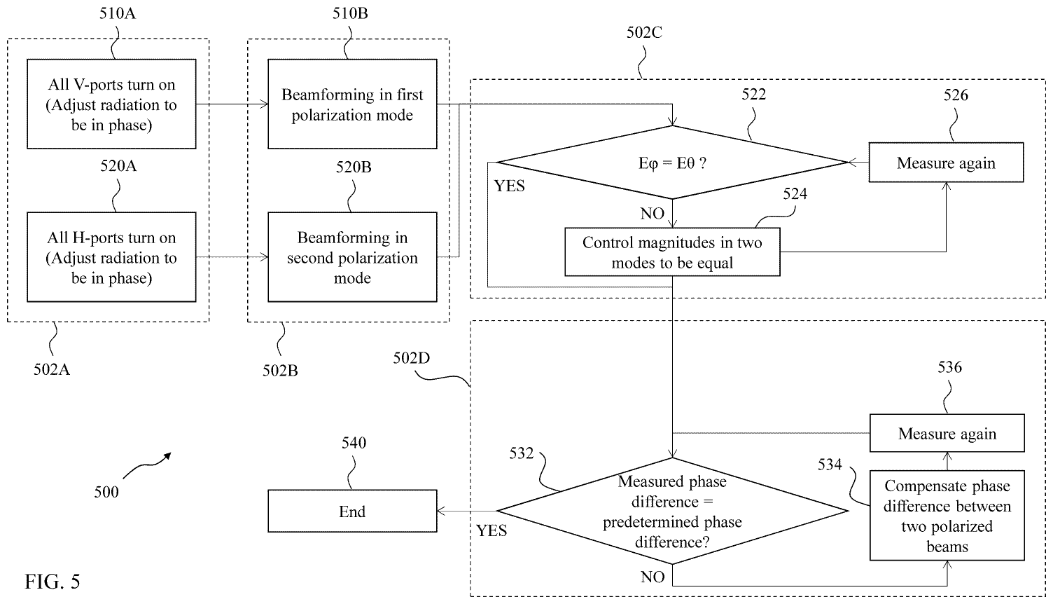

FIG. 5 illustrates an implementation of the axial ratio compensation method 300 shown in FIG. 3 in accordance with some embodiments of the present disclosure. In the present embodiment, the axial ratio compensation method 500 may include processes 502A to 502D. Step 510A in process 502A and step 510B in process 502B may serve as an embodiment of step 310 shown in FIG. 3; step 520A in process 502A and step 520B in process 502B may serve as an embodiment of step 320 shown in FIG. 3; at least one of processes 502C and 502D may serve as an embodiment of step 330 shown in FIG. 3.

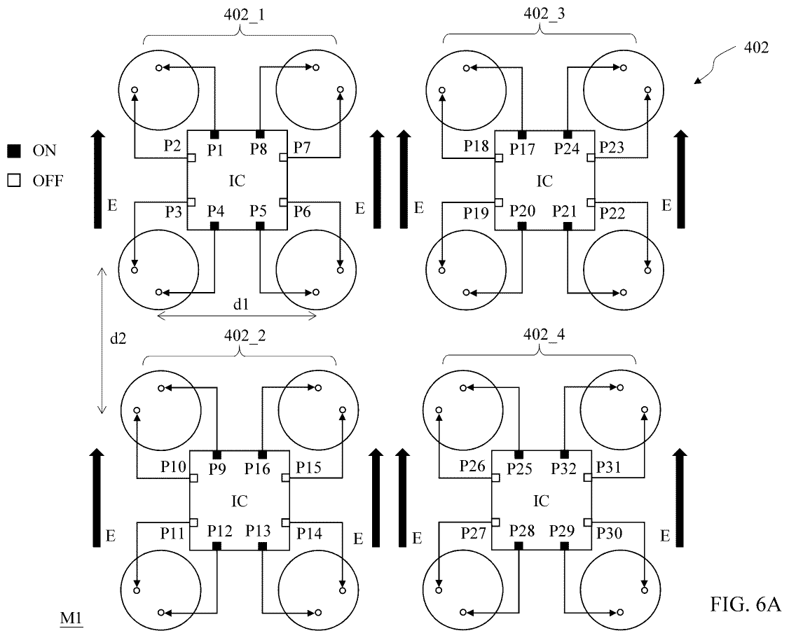

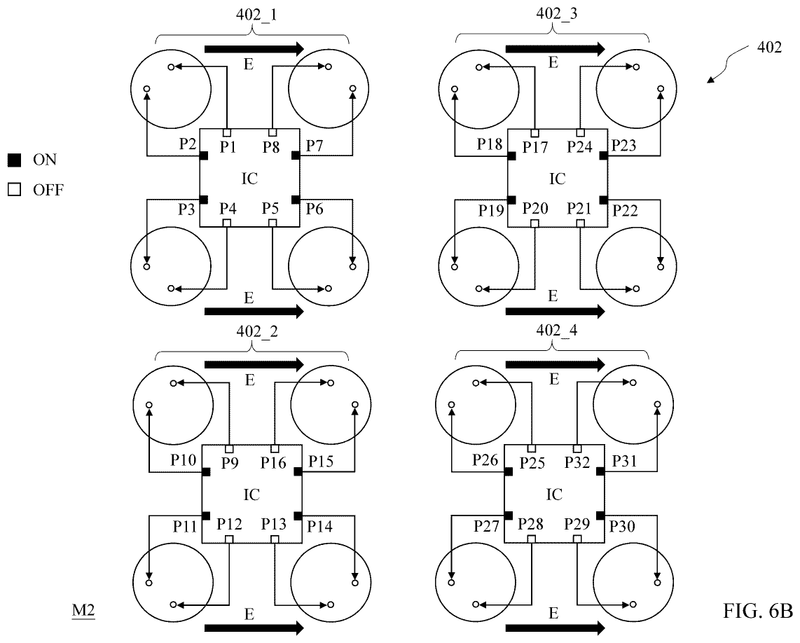

For illustrative purposes, the axial ratio compensation method 500 shown in FIG. 5 is described below with reference to FIG. 6A and FIG. 6B. FIG. 6A is an implementation of the antenna array 402 shown in FIG. 4 employing the axial ratio compensation method 500 shown in FIG. 5 to operate in a first polarization mode M1 in accordance with some embodiments of the present disclosure. FIG. 6B is an implementation of the antenna array 402 shown in FIG. 4 employing the axial ratio compensation method 500 shown in FIG. 5 to operate in a second polarization mode M2 in accordance with some embodiments of the present disclosure. In the embodiments shown in FIG. 6A and FIG. 6B, the antenna array 402 includes the subarrays 402_1 to 402_4, in which the subarrays 402_2 to 402_4 may have structures and operations substantially identical/similar to those of the subarray 402_1. The distance d1 between adjacent antenna elements within the same subarray may be equal to or substantially equal to half the wavelength of the electromagnetic wave transmitted by the antenna array 402, but this disclosure is not limited thereto. The distance d2 between adjacent antenna elements located in different subarrays may also be equal to or substantially equal to half the wavelength of the electromagnetic wave transmitted by the antenna array 402, but this disclosure is not limited thereto. Note that those skilled in the art will appreciate that the axial ratio compensation method 500 shown in FIG. 5 may be applied to other antenna arrays and/or antenna systems without departing from the scope of the present disclosure. Additionally, in some embodiments, other operations can be performed in the axial ratio compensation method 500. In some embodiments, operations of the axial ratio compensation method 500 can be performed in a different order and/or vary.

In process 502A, antenna input ports configured for the same polarization direction are turned on (or activated) across antenna elements, and far-field radiation (e.g., an electric field component E of an electromagnetic wave) from the antenna elements are aligned in phase. In some embodiments, the process 502A may be performed in near field to make the radiation from the antenna elements to be in phase.

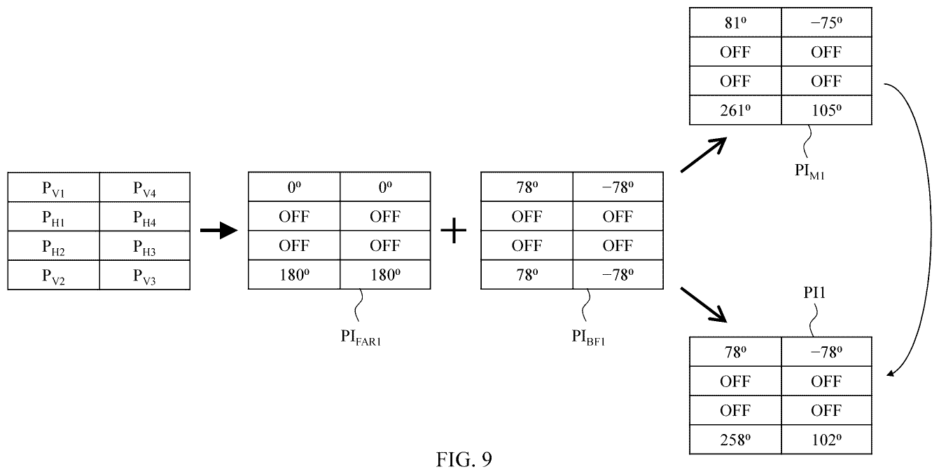

In the present embodiment, process 502A may include steps 510A and 520A. In step 510A, the antenna array 202 operates in the first polarization mode M1 (as shown in FIG. 6A) to turn on the ports P1, P4, P5, P8, P9, P12, P13, P16, P17, P20, P21, P24, P25, P28, P29 and P32, thereby turning on (or exciting) the ports of the antenna elements configured for the same polarization direction (e.g., ports configured for vertical polarization, referred to as V-ports). In addition, first aligning information PI_{FAR1} (as shown in FIG. 9) is applied to the turned-on ports. The first aligning information PI_{FAR1} includes phases for aligning vertically polarized far-field radiation from the antenna elements to be in phase. For example, in the subarray 402_1, the ports P_{V1}, P_{V2}, P_{V3} and P_{V4} configured for the vertical polarization may be activated, and applied with phases indicated by the first aligning information PI_{FAR1}, such that the vertically polarized far-field radiation from the antenna elements 404_1 to 404_4 can be aligned in phase.

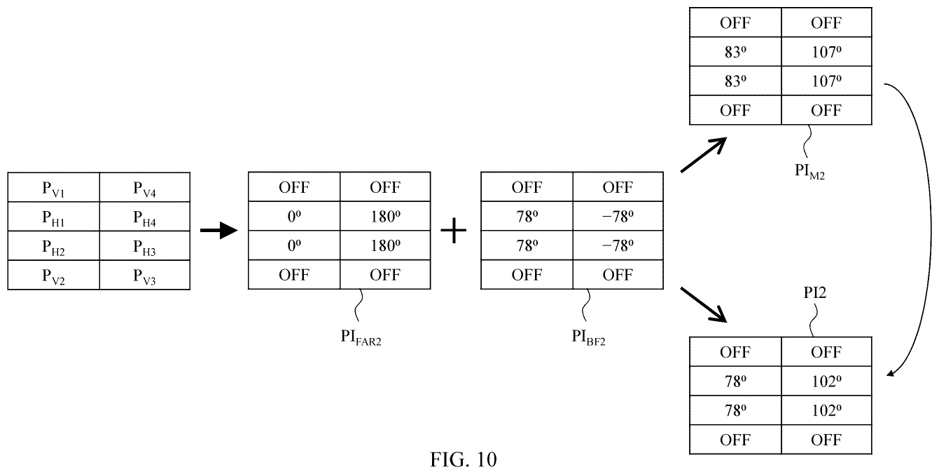

Similarly, in step 520A, the antenna array 202 operates in the mode M2 (as shown in FIG. 6B) to turn on the ports P2, P3, P6, P7, P10, P11, P14, P15, P18, P19, P22, P23, P26, P27, P30 and P31, thereby turning on (or exciting) the ports of the antenna elements configured for the same polarization direction (e.g., ports configured for horizontal polarization, referred to as H-ports). In addition, second aligning information PI_{FAR2} (as shown in FIG. 10) is applied to the turned-on ports. The second aligning information PI_{FAR2} includes phases for aligning horizontally polarized far-field radiation from the antenna elements to be in phase. For example, in the subarray 402_1, the ports P_{H1}, P_{H2}, P_{H3} and P_{H4} configured for the horizontal polarization may be activated and applied with phases indicated by the second aligning information PI_{FAR2}, such that the horizontally polarized far-field radiation from antenna elements 104_1 to 104_4 can be aligned in phase. In some embodiments, all of the V-ports and H-ports may be turned on to perform steps 510A and 520A concurrently.

In process 502B, phases at the activated antenna input ports in each polarization mode are further configured to perform beamforming toward a predetermined direction or a target angle. For example, the phases at the antenna input ports may be configured by making a direction of maximum radiation (e.g. a main lobe direction) or a direction of a predetermined side lobe of the antenna array match or approximate the predetermined direction (or the target angle).

In the present embodiment, process 502B may include steps 510B and 520B. In step 510B, the computing device 430 may combine the first aligning information PI_{FAR1} used in step 510A with corresponding first direction information PI_{BF1} (as shown in FIG. 9) (which is used for determining the predetermined direction of beamforming in the first polarization mode M1) to generate the first beamforming information PI1 for each integrated circuit.

Similarly, in step 520B, the computing device 430 may combine the second aligning information PI_{FAR2} used in step 520A with corresponding second direction information PI_{BF2} (as shown in FIG. 10) (which is used for determining the predetermined direction of beamforming in the second polarization mode M2) to generate the second beamforming information PI2 for each integrated circuit. In some embodiments, all of the V-ports and H-ports may be turned on to perform steps 510B and 520B concurrently.

After process 502B is finished, when the antenna array 202 is operated in the first polarization mode M1, a beam having the first polarization direction (e.g., the first linearly polarized beam L1 in FIG. 4) directed to the predetermined direction can be generated, where the beam has an electric field Eθ (e.g., the electric field component in the e-direction of a spherical coordinate system). Similarly, after process 502B is finished, when the antenna array 202 is operated in the second polarization mode M2, a beam having the second polarization direction (e.g., the second linearly polarized beam L2 in FIG. 4) directed to the predetermined direction can be generated, where the beam has an electric field Eφ (e.g., the electric field component in the o-direction). In process 502C, the magnitudes of the electric field Eθ and the electric field Eφ in the first and second polarization modes M1 and M2 are measured, and the measured magnitudes of the electric fields Eθ and Eφ are compared. If the measured magnitudes of the electric fields Eθ and Eφ are unequal, the signal strength applied to the corresponding antenna input port(s) may be adjusted so that the measured magnitudes of the electric fields Eθ and Eφ become equal or substantially equal. For example, in some cases where beamforming is performed at large angles, the magnitude of the electric field Eθ measured in the first polarization mode M1 may differ from the magnitude of the electric field Eφ measured in the second polarization mode M2. By adjusting the electric field magnitudes of the corresponding linearly polarized beams in the first and second polarization modes M1 and M2 to be equal (or substantially equal), if the two linearly polarized beams are orthogonal, the antenna array 402 can emit a beam having good circular polarization characteristics when both of the first and second polarization modes M1 and M2 are activated (i.e., all antenna input ports corresponding to different polarization directions are excited).

In the present embodiment, process 502C may include steps 522 to 526. In step 522, the analyzer 420 measures the respective magnitudes of the electric fields Eθ and Eφ, and the computing device 430 determines whether the magnitudes of the electric fields Eθ and Eφ are equal/matched. If it is determined that the magnitudes of the electric fields Eθ and Eφ are equal or matched, proceed to process 502D; otherwise, proceed to step 524. By way of example but not limitation, in the subarray 402_1, the integrated circuit 406_1 may obtain the magnitude of the electric field Eθ in the first polarization mode M1 shown in FIG. 6A, obtain the magnitude of the electric field Eφ in the second polarization mode M2 shown in FIG. 6B, and compare the magnitudes of the electric fields Eθ and Eφ to generate a comparison result. In some embodiments, all of the V-ports and H-ports may be turned on so that the magnitudes of the electric field Eθ and the electric field Eφ may be measured concurrently in step 522. When the comparison result indicates that the magnitudes of the electric fields Eθ and Eφ are equal or substantially equal, the flow proceeds to process 502D. If the comparison result indicates that the magnitudes of the electric fields Eθ and Eφ are different, the flow proceeds to step 524.

In step 524, the computing device 430 can control the integrated circuit to adjust the signal strength provided to the antenna input port(s), thereby controlling the electric field magnitudes measured in the first and second polarization modes M1 and M2 to be equal or substantially equal. By way of example but not limitation, in the subarray 402_1, when the magnitude of the electric field E is less than that of the electric field Eφ, the computing device 430 may control the integrated circuit 406_1 to increase the signal strength applied to the ports P_{V1}, P_{V2}, P_{V3} and P_{V4} to thereby increasing the magnitude of the electric field Eθ. Additionally or alternatively, the computing device 430 may control the integrated circuit 406_1 to decrease the signal strength applied to the ports P_{H1}, P_{H2}, P_{H3} and P_{H4} to thereby decreasing the magnitude of the electric field E. When the magnitude of the electric field Eφ is less than that of the electric field Eθ, the computing device 430 may control the integrated circuit 406_1 to increase the signal strength applied to the ports P_{H1}, P_{H2}, P_{H3} and P_{H4} to thereby increasing the magnitude of the electric field Eφ. Additionally or alternatively, the computing device 430 may control the integrated circuit 406_1 to decrease the signal strength applied to the ports P_{V1}, P_{V2}, P_{V3} and P_{V4} to thereby decreasing the magnitude of the electric field Eθ. In some embodiments, the signal strength of the ports P_{H1}, P_{H2}, P_{H3} and P_{H4} may be adjusted by the same value in step 524. Alternatively, the signal strength of the ports P_{V1}, P_{V2}, P_{V3} and P_{V4} may be adjusted by the same value in step 524; however, the present disclosure is not limited thereto.

In step 526, the electric field magnitudes in the two modes can be measured again to check whether the adjusted electric field magnitudes have become equal or substantially equal. For example, each integrated circuit may again excite the corresponding antenna input ports in the first and second polarization modes M1 and M2, the analyzer 420 and the computing device 430 may then collaboratively execute step 522 to measure the magnitudes of the electric fields Eθ and Eφ and to determine whether the magnitudes of the electric fields Eθ and Eφ are matched.

Next, in process 502D, a phase difference between the beam of the first polarization mode M1 and the beam of the second polarization mode M2 is measured. When the phase difference between the two linearly polarized beams does not equal or does not match a predetermined phase difference, the computing device 430 may control the integrated circuit 406_1 to adjust a phase of an electrical signal applied to the antenna input port(s), to thereby adjust the phase difference to the predetermined phase difference. For example, the phase difference between the two linearly polarized beams may deviate from 90° at large beamforming angles. By adjusting this phase difference to 90° (or substantially) 90°, and controlling the electric field magnitudes of the two linearly polarized beams in the first and second polarization modes M1 and M2 to be equal or substantially equal, the antenna array 402 may achieve full-angle beamforming capability and improved far-field circular polarization characteristics.

In the present embodiment, process 502D may include steps 532 to 536. In step 532, the analyzer 420 may measure the phase difference between the two linearly polarized beams corresponding to different polarization directions, and determine whether the measured phase difference equals the predetermined phase difference. In some embodiments, all of the V-ports and H-ports may be turned on so that the phases of the two linearly polarized beams may be measured concurrently in step 532. When it is determined that the measured phase difference equals the predetermined value, proceed to step 540 to complete the axial ratio compensation; otherwise, proceed to step 536. In step 536, the computing device 430 may control the integrated circuit 406_1 to adjust the phase of the electrical signal provided to the antenna input port, so as to accordingly adjust the phase difference to be equal to (or substantially equal to) the predetermined phase difference. In some embodiments, the integrated circuit 406_1 may adjust the signal phase of the ports P_{H1}, P_{H2}, P_{H3} and P_{H4} by the same value to compensate the phase difference between the two linearly polarized beams to be equal to (or substantially equal to) the predetermined phase difference. Alternatively, the integrated circuit 406_1 may adjust the signal phase of the ports P_{V1}, P_{V2}, P_{V3} and P_{V4} by the same value; however, the present disclosure is not limited thereto. In step 538, the phase difference between the two linearly polarized beams can be measured again to check whether the adjusted phase difference equals or substantially equals the predetermined phase difference.

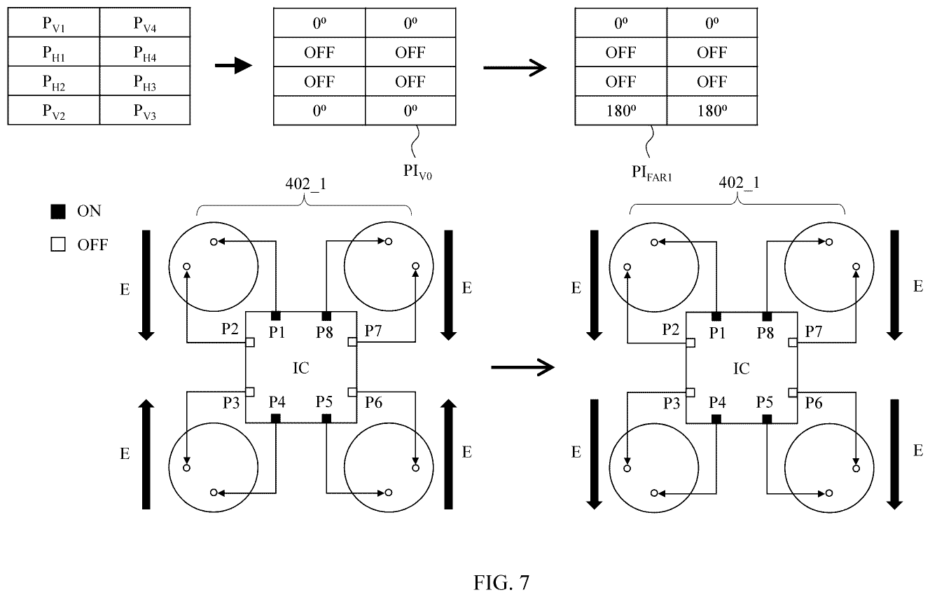

For illustrative purposes, FIG. 7 to FIG. 10 illustrate exemplary beamforming information, aligning information, and direction information associated with the ports in the subarray 402_1 shown in FIG. 4, which employs the axial ratio compensation method 500 shown in FIG. 5 to improve circular polarization characteristics (e.g., an axial ratio), in accordance with some embodiments of the present disclosure. However, those skilled in the art will appreciate that the circular polarization compensation performed by the subarray 402_1 shown in FIG. 4 may involve different phase values or different configurations of these information without departing from the scope of the present disclosure.

Referring firstly to FIG. 7, the operations and phase information involved when the subarray 402_1 shown in FIG. 4 performs step 510A of the axial ratio compensation method 500 shown in FIG. 5 are illustrated in accordance with some embodiments of the present disclosure. The subarray 402_1 may determine the first aligning information PI_{FAR1} by aligning the far-field radiation (e.g., vertically polarized far-field radiation) from the antenna elements 104_1 to 104_4 to be in phase. In the present embodiment, ports P1, P4, P5 and P8 are activated to excite the ports P_{V1}, P_{V2}, P_{V3} and P_{V4} (e.g., the ports configured for vertical polarization), while the ports P2, P3, P6 and P7 may be selectively deactivated such that the ports P_{H1} to P_{H4} (e.g., the ports configured for horizontal polarization) remain unexcited. The far-field radiation from the antenna elements 104_1 to 104_4 is generated in response to excitation of the ports P_{V1} to P_{V4} when the ports P_{H1} to P_{H4} remain unexcited.

By way of example but not limitation, the integrated circuit 406_1 may firstly output electrical signals having the same phase (e.g., 0°) from the ports P1, P4, P5 and P8 according to the phase information PI_{V0} (represented as a phase table), and accordingly excite the ports P_{V1} to P_{V4}. When viewed from directly above the subarray 402_1, the antenna elements 104_1 and 104_2 exhibit opposite electric field phases in the array normal direction, and the antenna elements 104_3 and 104_4 exhibit opposite electric field phases in the array normal direction, resulting in a null at the center of the far-field pattern. The computing device 430 may control the integrated circuit 406_1 to adjust the phase of the electrical signals output from the ports P4 and P5 to 180°, thereby ensuring that the electric fields from the antenna elements 104_1 to 104_4 are in phase in the array normal direction, and avoiding the formation of a null at the center of the far-field pattern. The computing device 430 may record the adjusted phase table as the first aligning information PI_{FAR1}.

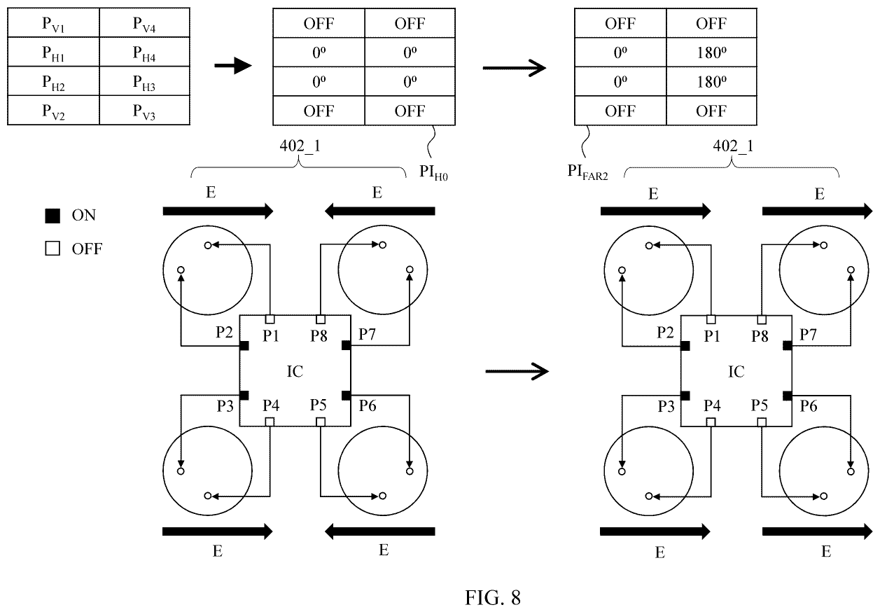

Referring to FIG. 8, the operations and phase information involved when the subarray 402_1 shown in FIG. 4 performs step 520A of the axial ratio compensation method 500 shown in FIG. 5 are illustrated in accordance with some embodiments of the present disclosure. The subarray 402_1 may determine the second aligning information PI_{FAR2} by aligning the far-field radiation (e.g., horizontally polarized far-field radiation) from the antenna elements 104_1 to 104_4 to be in phase. In the present embodiment, ports P2, P3, P6 and P7 are activated to excite the ports P_{H1} to P_{H4} (e.g., the ports configured for horizontal polarization), while the ports P1, P4, P5 and P8 may be selectively deactivated such that the ports P_{V1}, P_{V2}, P_{V3} and P_{V4} (e.g., the ports configured for vertical polarization) remain unexcited. The far-field radiation from the antenna elements 104_1 to 104_4 is generated in response to excitation of the ports P_{H1} to P_{H4} when the ports P_{V1} to P_{V4} remain unexcited.

By way of example but not limitation, the integrated circuit 406_1 may firstly output electrical signals having the same phase (e.g., 0°) from the ports P2, P3, P6 and P7 according to the phase information PI_{H0} (represented as a phase table), and accordingly excite the ports P_{H1} to P_{H4}. When viewed from directly above the subarray 402_1, the antenna elements 104_1 and 104_4 exhibit opposite electric field phases in the array normal direction, and the antenna elements 104_2 and 104_3 exhibit opposite electric field phases in the array normal direction, resulting in a null at the center of the far-field pattern. The computing device 430 may control the integrated circuit 406_1 to adjust the phase of the electrical signals output from the ports P6 and P7 to 180°, thereby ensuring that the electric fields from the antenna elements 104_1 to 104_4 are in phase in the array normal direction, and avoiding the formation of a null at the center of the far-field pattern. The computing device 430 may record the adjusted phase table as the second aligning information PI_{FAR2}.

FIG. 9 is a diagram illustrating the operations and phase information involved when the subarray 402_1 shown in FIG. 4 performs step 510B of the axial ratio compensation method 500 shown in FIG. 5 in accordance with some embodiments of the present disclosure. Referring to FIG. 9 and also to FIG. 4, the computing device 430 may combine the first aligning information PI_{FAR1} with the first direction information PI_{BF1} (represented as a phase table) to generate the first beamforming information PI1 (represented as a phase table). The first direction information PI_{BF1} is used for beamforming operations at a scan angle of 60° (i.e., the angle between the array normal direction and the predetermined direction) in the mode M1. In addition, the computing device 430 may determine whether a direction of maximum radiation/predetermined side lobe matches the predetermined direction. When it is determined that the direction of maximum radiation deviates from the predetermined direction, the computing device 430 can control the subarray 402_1 to calibrate the direction of maximum radiation or the direction of the predetermined side lobe to the predetermined direction corresponding to the first beamforming information PI1, by adjusting the phases at the activated antenna input ports.

In the present embodiment, the integrated circuit 406_1 may transmit electrical signals from the ports P1, P4, P5 and P8 to the ports P_{V1}, P_{V2}, P_{V3} and P_{V4} according to the first beamforming information PI1, thereby driving the antenna elements 104_1 to 104_4 to emit the electromagnetic signal SEM (e.g., the first linearly polarized beam L1). The computing device 430 may determine whether the direction of maximum radiation/predetermined side lobe of the subarray 402_1 (or the antenna array 402) matches the predetermined direction (corresponding to a scan angle of) 60° according to the measurement result of the electromagnetic signal SEM. By way of example but not limitation, the computing device 430 may determine the direction of maximum radiation/predetermined side lobe according to the analysis data S_{DA}. Due to mutual coupling between the antenna elements or other reasons, the practical direction of maximum radiation/predetermined side lobe may be equivalent to a direction indicated by the phase information PI_{M1}. The integrated circuit 406_1 may adjust the phases of the electrical signals outputted from the ports P1, P4, P5 and/or P8 to the ports P_{V1} to P_{V4} such that the direction of maximum radiation/predetermined side lobe matches the ideal direction indicated by the first beamforming information PI1.

FIG. 10 is a diagram illustrating the operations and phase information involved when the subarray 402_1 shown in FIG. 4 performs step 520B of the axial ratio compensation method 500 shown in FIG. 5 in accordance with some embodiments of the present disclosure. Referring to FIG. 10 and also to FIG. 4, the computing device 430 may combine the second aligning information PI_{FAR2} with the second direction information PI_{BF2} (represented as a phase table) to generate the second beamforming information PI2 (represented as a phase table). The second direction information PI_{BF2} is used for beamforming operations at a scan angle of 60° (i.e., the angle between the array normal direction and the predetermined direction) in the mode M2. In addition, the computing device 430 may determine whether a direction of maximum radiation/predetermined side lobe matches the predetermined direction. When it is determined that the direction of maximum radiation deviates from the predetermined direction, the computing device 430 can control the subarray 402_1 to calibrate the direction of maximum radiation/predetermined side lobe to the predetermined direction by adjusting the phases at the activated antenna input ports.

In the present embodiment, the integrated circuit 406_1 may transmit electrical signals from the ports P2, P3, P6 and P7 to the ports P_{H1}, P_{H2}, P_{H3} and P_{H4} according to the second beamforming information PI2, thereby driving the antenna elements 104_1 to 104_4 to emit the electromagnetic signal SEM (e.g., second linearly polarized beam L2). The computing device 430 may determine whether the direction of maximum radiation of the subarray 402_1 (or the direction of maximum radiation of the antenna array 402) matches the predetermined direction (corresponding to a scan angle of) 60° according to the measurement result of the electromagnetic signal SEM. By way of example but not limitation, the computing device 430 may determine the direction of maximum radiation/predetermined side lobe according to the analysis data S_{DA}. In some embodiments, due to mutual coupling between the antenna elements or other reasons, the practical direction of maximum radiation/predetermined side lobe may be equivalent to a direction indicated by the phase information PI_{M2}. The computing device 430 can control the integrated circuit 406_1 to adjust the phases of the electrical signals outputted from the ports P2, P3, P6 and/or P7 to the ports P_{H1} to P_{H4} such that the direction of maximum radiation/predetermined side lobe matches the ideal direction indicated by the second beamforming information PI2.

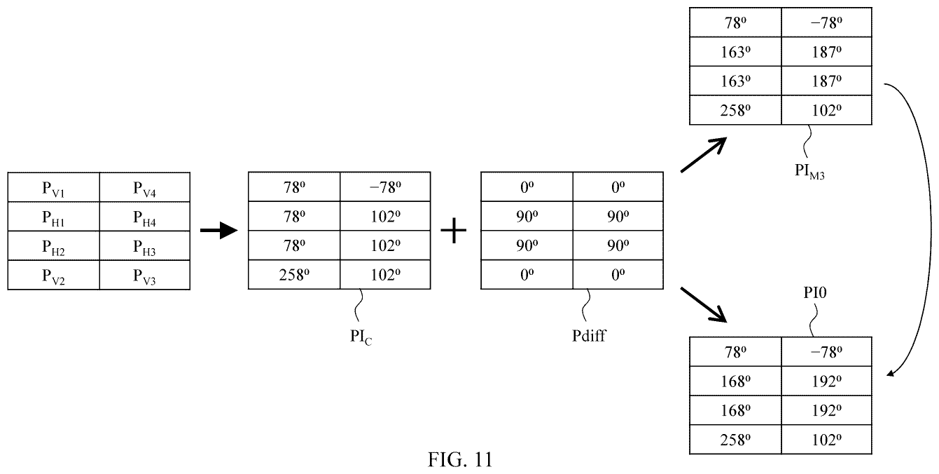

FIG. 11 is a diagram illustrating the operations and phase information involved when the subarray 402_1 shown in FIG. 4 performs process 502D of the axial ratio compensation method 500 shown in FIG. 5 in accordance with some embodiments of the present disclosure. Referring to FIG. 11 and also to FIG. 4, the integrated circuit 406_1 may concurrently excite two ports of each antenna element (configured for vertical polarization and horizontal polarization) according to the first beamforming information PI1 and the second beamforming information PI2 to emit the electromagnetic signal SEM including the first linearly polarized beam L1 and the second linearly polarized beam L2. Then, the computing device 430 may control the integrated circuit 406_1 to apply the phase difference information Pdiff to the ports P_{V1} to P_{V4} and P_{H1} to P_{H4}, and the analyzer 420 may accordingly measure the phase difference between the two linearly polarized beams L1 and L2. Additionally, the computing device 430 may compare the measured phase difference with the predetermined phase difference indicated by the phase difference information Pdiff. If the measured phase difference does not equal the predetermined phase difference, the computing device 430 can control the integrated circuit 406_1 to adjust the phase difference to match the predetermined phase difference.

In the present embodiment, the phase information PI_{C} represents the combination of the first beamforming information PI1 and the second beamforming information PI2, and the phase difference information Pdiff indicates that the predetermined phase difference between the two linearly polarized beams L1 and L2 is 90°. The integrated circuit 406_1 may transmit electrical signals from the ports P1 through P8 to the ports P_{V1} to P_{V4} and the ports P_{H1} to P_{H4} according to the combination of the phase information PI_{C} and the phase difference information Pdiff (i.e., the phase information PI0), thereby driving the antenna elements 104_1 to 104_4 to emit the electromagnetic signal SEM (e.g., a circularly polarized beam). Thereafter, the computing device 430 may determine whether the measured phase difference between the two linearly polarized beams L1 and L2 equals 90° according to the measurement result of the electromagnetic signal SEM.

By way of example but not limitation, the computing device 430 may obtain the phase difference between the two linearly polarized beams L1 and L2. When the measured phase difference do not match the phase difference indicated by the phase difference information Pdiff, this may represent that the circular polarization characteristics (e.g., an axial ratio) of the electromagnetic signal SEM can be further improved. For example, due to mutual coupling between the antenna elements or other reasons, the electromagnetic signal SEM formed by the polarized beams L1 and L2 may correspond to the phase information PI_{M3}, and the phase difference between the two linearly polarized beams L1 and L2 is 85°. In such cases, the integrated circuit 406_1 may adjust the phase of at least one of the electrical signals outputted from the ports P1 to P8, thereby generating the electromagnetic signal SEM corresponding to the phase information PI0.

Note that the above-described phase values or phase configurations are provided for illustrative purposes, and are not intended to limit the scope of the present disclosure. In some embodiments, the predetermined direction PD shown in FIG. 4 may correspond to a scan angle equal to or exceeding 30°. In other words, the proposed axial ratio compensation scheme can be applied to beamforming operations toward relatively large scan angles. In some embodiments, one or more operations/steps in process 502C of FIG. 5 may be optional. For example, after process 502B is performed, the flow may proceed to process 502D without performing adjustments to the magnitudes of the electric fields Eθ and/or Eφ. As another example, when the measured magnitudes of the electric fields Eθ and Eφ are matched, or the difference therebetween falls within a predetermined range, the flow may proceed to process 502D without performing adjustments to the magnitudes of the electric fields Eθ and/or Eφ. As still another example, after the magnitudes of the electric fields Eθ and/or Eφ are adjusted (i.e. after step 524 is performed), the flow may proceed to process 502D without measuring the magnitudes of the electric fields Eθ and/or Eφ again.

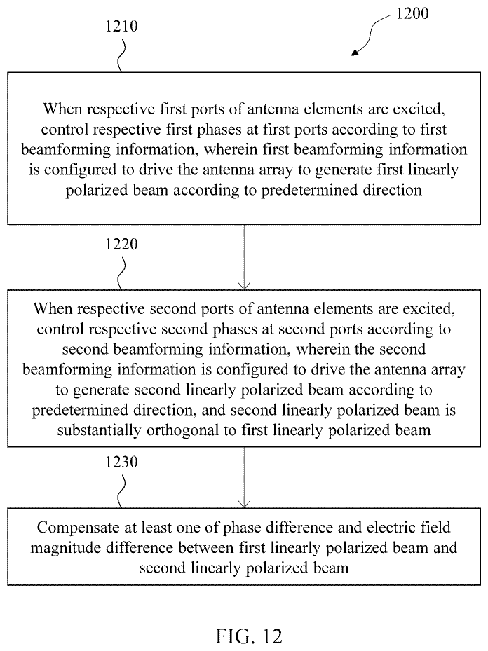

In some embodiments, the proposed axial ratio compensation scheme may be implemented using the axial ratio compensation method 1200 shown in FIG. 12. FIG. 12 illustrates an implementation of the axial ratio compensation method 300 shown in FIG. 3 in accordance with some embodiments of the present disclosure. In the present embodiment, the axial ratio compensation method 1200 may include steps 1210, 1220, and 1230. Step 1210 may represent an embodiment of step 310 shown in FIG. 3; step 1220 may represent an embodiment of step 320 shown in FIG. 3; step 1230 may represent an embodiment of step 330 shown in FIG. 3. For illustrative purposes, the axial ratio compensation method 1200 is described below with reference to the antenna array 402 shown in FIG. 4. Those skilled in the art can appreciate that the axial ratio compensation method 1200 may be applied to other antenna arrays and/or antenna systems without departing from the scope of the present disclosure. Additionally, in some embodiments, other operations can be performed in the axial ratio compensation method 1200. In some embodiments, operations of the axial ratio compensation method 1200 can be performed in a different order and/or vary.

In step 1210, when respective first ports of antenna elements included in the antenna array are excited, respective first phases at the first ports are controlled according to first beamforming information. The first beamforming information is configured to drive the antenna array to generate a first linearly polarized beam according to a predetermined direction. For example, when the ports P_{V1}, P_{V2}, P_{V3} and P_{V4} are excited, the integrated circuit 406_1 may control the respective phases at the ports P_{V1}, P_{V2}, P_{V3} and P_{V4} according to the first beamforming information PI1. The first beamforming information PI1 may be configured to drive the antenna array 402 to generate the first linearly polarized beam L1 directed toward the predetermined direction PD.

In step 1220, when respective second ports of the antenna elements are excited, respective second phases at the second ports are controlled according to second beamforming information. The second beamforming information is configured to drive the antenna array to generate a second linearly polarized beam according to the predetermined direction. The second linearly polarized beam is substantially orthogonal to the first linearly polarized beam. For example, when the ports P_{H1}, P_{H2}, P_{H3} and P_{H4} are excited, the integrated circuit 406_1 may control the respective phases of ports P_{H1}, P_{H2}, P_{H3} and P_{H4} according to the second beamforming information PI2, which is configured to drive the antenna array 402 to generate the second linearly polarized beam L2 directed toward the predetermined direction PD.

In step 1230, at least one of the phase difference and the electric field magnitude difference between the first linearly polarized beam and the second linearly polarized beam is compensated to form a predetermined circularly polarized beam directed toward the predetermined direction. For example, the integrated circuit 406_1 may compensate the phase difference between the first linearly polarized beam L1 and the second linearly polarized beam L2 according to the predetermined phase difference indicated by the phase difference information Pdiff.

In some embodiments, the computing device 430 can control the integrated circuit 406_1 to use the first aligning information PI_{FAR1} shown in FIG. 9 to align the far-field radiation from the antenna elements 104_1 to 104_4 (e.g., vertically polarized far-field radiation) to be in phase. The computing device 430 may combine the first aligning information PI_{FAR1} with the first direction information PI_{BF1} to generate the first beamforming information PI1. In some embodiments, the computing device 430 may determine whether a direction of maximum radiation of the antenna array 402 (corresponding to the main lobe of the beam emitted by the antenna array 402) matches the predetermined direction PD. When it is determined that the direction of maximum radiation deviates from the predetermined direction PD, the computing device 430 may control the integrated circuit 406_1 to adjust the phases at the ports P_{V1} to P_{V4} so as to make the direction of maximum radiation match the predetermined direction PD indicated by the first beamforming information PI1.

Similarly, the computing device 430 may control the integrated circuit 406_1 to use the second aligning information PI_{FAR2} shown in FIG. 10 to align the far-field radiation from the antenna elements 104_1 to 104_4 (e.g., horizontally polarized far-field radiation) to be in phase. The computing device 430 may combine the second aligning information PI_{FAR2} with the second direction information PI_{BF2} to generate the second beamforming information PI2. In some embodiments, the computing device 430 may determine whether a direction of maximum radiation of the antenna array 402 (corresponding to the main lobe of the beam emitted by the antenna array 402) matches the predetermined direction PD. When it is determined that the direction of maximum radiation deviates from the predetermined direction PD, the computing device 430 may control the integrated circuit 406_1 to adjust the phases at the ports P_{H1} to P_{H4} so as to make the direction of maximum radiation match the predetermined direction PD indicated by the second beamforming information PI2.

In some embodiments, the computing device 430 may control the integrated circuit 406_1 to adjust the electric field magnitude of the first linearly polarized beam L1 corresponding to the first beamforming information PI1 to be equal to the electric field magnitude of the second linearly polarized beam L2 corresponding to the second beamforming information PI2. For example, the analyzed 420 may concurrently or separately measure the electric field magnitudes of the polarized beams L1 and L2, and the computing device 430 may compare the measured electric field magnitudes to generate a comparison result. The computing device 430 can control the integrated circuit 406_1 to adjust the electric field magnitudes of the polarized beams L1 and L2 to be equal or matched by adjusting the electric field magnitude of the polarized beam L1 and/or the electric field magnitude of the polarized beam L2.

As those skilled in the art will appreciate the operation of the axial ratio compensation method 1200 after reading the above paragraphs directed to FIG. 1 to FIG. 11, further description is omitted here for brevity.

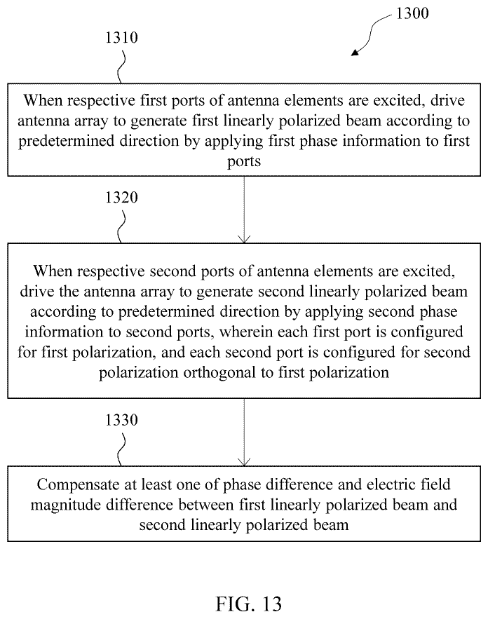

In some embodiments, the proposed axial ratio compensation scheme may be implemented using the axial ratio compensation method 1300 shown in FIG. 13. FIG. 13 illustrates another implementation of the axial ratio compensation method 300 shown in FIG. 3 in accordance with some embodiments of the present disclosure. In the present embodiment, the compensation method 1300 may include steps 1310, 1320, and 1330. Step 1310 may represent an embodiment of step 310 shown in FIG. 3; step 1320 may represent an embodiment of step 320 shown in FIG. 3; step 1330 may represent an embodiment of step 330 shown in FIG. 3. For illustrative purposes, the axial ratio compensation method 1300 is described below with reference to the antenna array 402 shown in FIG. 4. Those skilled in the art can appreciate that the axial ratio compensation method 1300 may be applied to other antenna arrays and/or antenna systems without departing from the scope of the present disclosure. Additionally, in some embodiments, other operations can be performed in the axial ratio compensation method 1300. In some embodiments, operations of the axial ratio compensation method 1300 can be performed in a different order and/or vary.

In step 1310, when respective first ports of antenna elements included in the antenna array are excited, the antenna array is driven to generate a first linearly polarized beam according to a predetermined direction by applying first beamforming information to the first ports. Each first port is configured for a first polarization, and each second port is configured for a second polarization orthogonal to the first polarization. For example, when the ports P_{V1}, P_{V2}, P_{V3} and P_{V4} are excited, and the ports P_{H1}, P_{H2}, P_{H3} and P_{H4} are unexcited, the integrated circuit 406_1 may drive the antenna array 402 to generate the first linearly polarized beam L1 directed toward the predetermined direction PD by applying the first beamforming information PI1 to the ports P_{V1}, P_{V2}, P_{V3} and P_{V4}.

In step 1320, when respective second ports of the antenna elements are excited, the antenna array is driven to generate a second linearly polarized beam according to the predetermined direction by applying second beamforming information to the second ports. For example, when the ports P_{V1}, P_{V2}, P_{V3} and P_{V4} are unexcited, and the ports P_{H1}, P_{H2}, P_{H3} and P_{H4} are excited, the integrated circuit 406_1 may drive the antenna array 402 to generate the polarized beam L2 directed toward the predetermined direction PD by applying the second beamforming information PI2 to the ports P_{H1}, P_{H2}, P_{H3} and P_{H4}.

In step 1330, at least one of the phase difference and the electric field magnitude difference between the first linearly polarized beam and the second linearly polarized beam is compensated to form a predetermined circularly polarized beam directed toward the predetermined direction. For example, the integrated circuit 406_1 may compensate the phase difference between the first linearly polarized beam L1 and the second linearly polarized beam L2 according to the predetermined phase difference indicated by the phase difference information Pdiff.

As those skilled in the art will appreciate the operation of the axial ratio compensation method 1300 after reading the above paragraphs directed to FIG. 1 to FIG. 12, further description is omitted here for brevity.

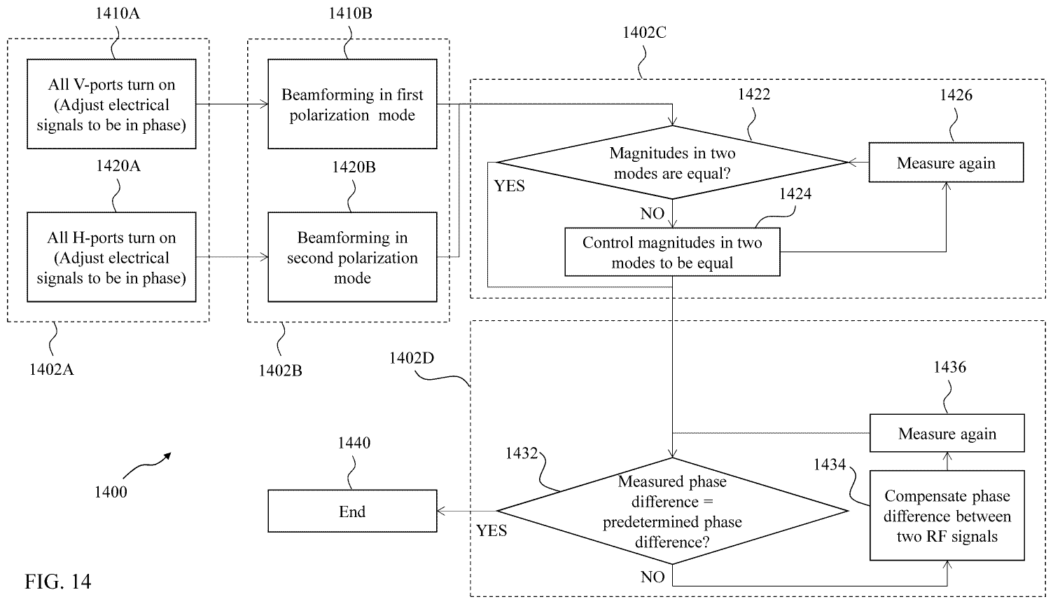

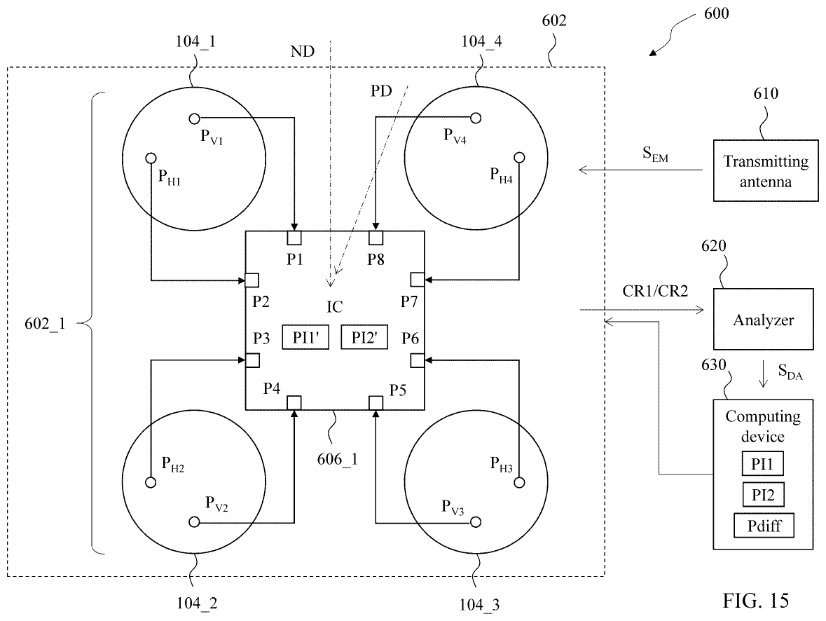

FIG. 14 is a flow chart of an exemplary axial ratio compensation method 1400 for an antenna array in accordance with some embodiments of the present disclosure. For illustrative purposes, the axial ratio compensation method 1400 is described below with reference to the antenna system 600 shown in FIG. 15. The antenna system 600 shown in FIG. 15 may include, but is not limited to, an antenna array 602, a transmitting antenna 610, an analyzer 620, and a computing device 630. The antenna array 602 includes a subarray 602_1. The structure of the subarray 602_1 is substantially identical/similar to that of the subarray 102_1 shown in FIG. 1 except that the integrated circuit 606_1 of the subarray 602_1 can be configured to perform the axial ratio compensation method 1400 shown in FIG. 14. Those skilled in the art will recognize that the axial ratio compensation method 1400 can be applied to other antenna elements/arrays having antenna input ports (or antenna feed ports) that corresponds to different polarizations without departing from the scope of the present disclosure. Additionally, in some embodiments, other operations can be performed in the axial ratio compensation method 1400. In some embodiments, operations of the axial ratio compensation method 1400 can be performed in a different order and/or vary.

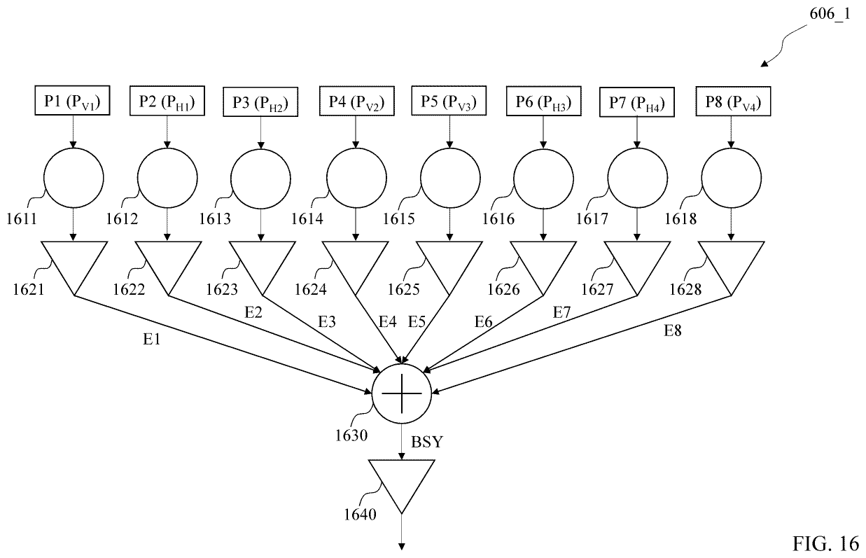

In the present embodiment, the axial ratio compensation method 1400 may include processes 1402A to 1402D. In process 1402A, antenna input ports configured for the same polarization direction are turned on (or activated) across antenna elements, and the RF signals generated by the antenna elements that are in phase. In the present embodiment, process 1402A may include steps 1410A and 1420A, which will be explained with reference to FIG. 16.

FIG. 16 is a diagram illustrating the integrated circuit 606_1 of FIG. 15 in accordance with some embodiments of the present disclosure. The integrated circuit 606_1 includes phase shifters 1611 to 1618, amplifiers 1621 to 1628, a signal combiner 1630, and a buffer 1640. The input terminals of the amplifiers 1621 to 1628 are coupled to the ports P_{V1} to P_{V4} and P_{H1} to P_{H4} through the phase shifters 1611 to 1618. The output terminals of the amplifiers 1621 to 1628 are coupled to input terminals of the signal combiner 1630, respectively. The output terminal of the signal combiner 1630 is coupled to the input terminal of the buffer 1640. The signal combiner 1630 is configured to combine the electrical signals E1 to E8 from the amplifiers 1621 to 1628 to generate a combined signal BSY. The buffer 1640 can buffer the combined signal BSY to generate the RF signal (i.e., a buffered version of the combined signal BSY).

In step 1410A, the antenna array 602 receives a first polarized beam from the normal direction ND of the antenna. The first polarized beam may be a vertically polarized beam of a circularly polarized beam. In addition, electrical signals E1, E4, E5, and E8 corresponding to the ports P_{V1}, P_{V2}, P_{V3}, and P_{V4} configured for the first polarization (e.g., the vertical polarization) are adjusted to be in phase. Specifically, one of the electrical signals E1, E4, E5, and E8 may be taken as a reference signal. For example, the port P1 may be turned on first and the other ports P2 to P8 may be turned off, by, for example, enabling the amplifier 1621 and disabling the other amplifiers 1622 to 1628; and the electrical signal E1 corresponding to the port P1 (i.e., corresponding to the port P_{V1}) is taken as a reference signal. Next, the other ports P4, P5, and P8 can be sequentially enabled, so that the electrical signals E4, E5, and E8 corresponding to the ports P4, P5, and P8 (i.e., corresponding to the ports P_{V2}, P_{V3}, and P_{V4}) can be sequentially aligned with the reference signal. For example, for aligning the electrical signal E4 with the reference signal (i.e., the electrical signal E1), the port P1 and P4 are enabled while the other ports P2, P3, and P5 to P8 are disabled, so that the signal combiner 1630 outputs a superposition signal of the electrical signals E1 and E4; then, the phase at the port P4 (i.e., the port P_{V2}) is adjusted by controlling the phase shifter 1614 to make the superposition signal having the maximum signal strength (e.g., the maximum signal amplitude). Each of the electrical signals E5 and E8 can be aligned with the reference signal by a process similar to that of the electrical signal E4; therefore, the detailed descriptions are omitted. In some embodiments, during step 1410A, the ports P2, P3, P6, and P7 may be disabled. After the step 1410A is finished, the computing device 630 may generate and store a first aligning information similar to the first aligning information PI_{FAR1} of FIG. 7.

Similarly, in step 1420A, the antenna array 602 receives a second polarized beam from the normal direction ND of the antenna. The second polarized beam may be a horizontally polarized beam or the circularly polarized beam. Electrical signals E2, E3, E6, and E7 corresponding to the ports P_{H1}, P_{H2}, P_{H3}, and P_{H4} configured for the second polarization (e.g., the horizontal polarization) are adjusted to be in phase. Specifically, one of the electrical signals E2, E3, E6, and E7 may be taken as a reference signal. For example, the port P2 may be turned on first and the other ports P1 and P3 to P8 may be turned off; and the electrical signal E2 corresponding to the port P2 (i.e., corresponding to the port P_{H1}) is taken as a reference signal. Next, the other ports P3, P6, and P7 can be sequentially enabled, so that the electrical signals E3, E6, and E7 corresponding to the ports P3, P6, and P7 (i.e., corresponding to the ports P_{H2}, P_{H3}, and P_{H4}) can be sequentially aligned with the reference signal. For example, for aligning the electrical signal E3 with the reference signal (i.e., the electrical signal E2), the port P2 and P3 are enabled while the other ports P1 and P4 to P8 are disabled, so that the signal combiner 1630 outputs a superposition signal of the electrical signals E2 and E3; then, the phase at the port P3 (i.e., the port P_{H2}) is adjusted by controlling the phase shifter 1614 to make the superposition signal having the maximum signal strength (e.g., the maximum signal amplitude). Each of the electrical signals E6 and E7 can be aligned with the reference signal by a process similar to that of the electrical signal E3; therefore, the detailed descriptions are omitted. In some embodiments, during step 1410B, the ports P1, P4, P5, and P8 may be disabled. After the step 1410B is finished, the integrated circuit 606_1 may generate and store a second aligning information similar to the second aligning information PI_{FAR2} of FIG. 8. In some embodiments, all of the V-ports and H-ports may be turned on to perform steps 1410A and 1420A concurrently.

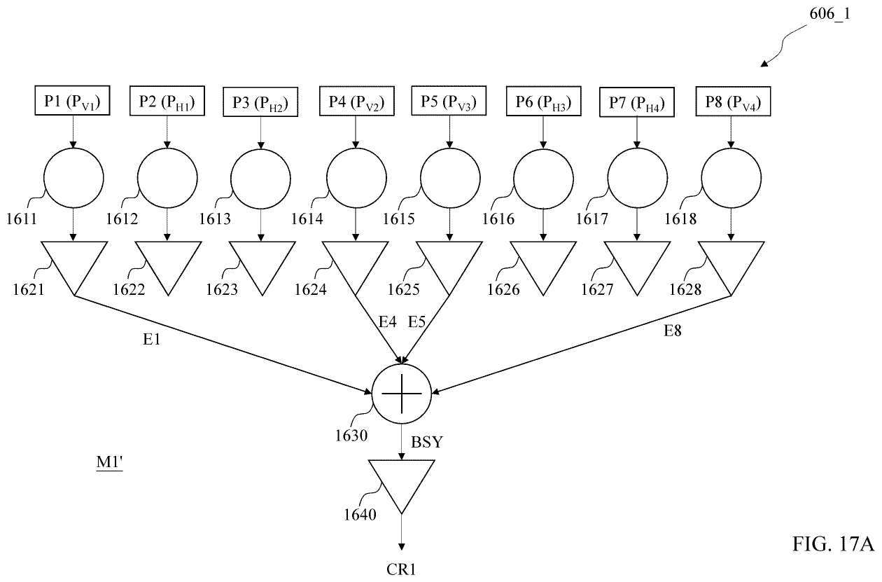

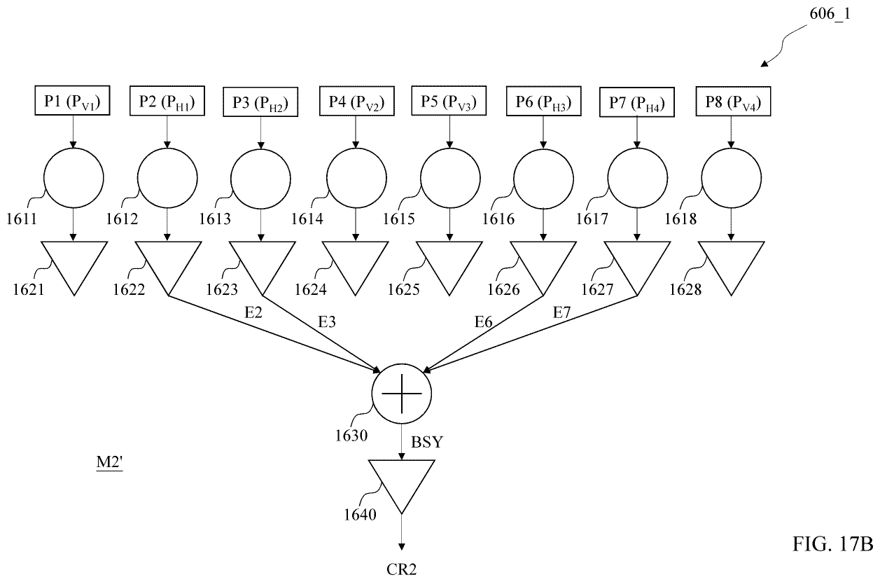

In process 1402B, phases at the ports P_{V1} to P_{V4} and P_{H1} to P_{H4} are further configured to perform beamforming toward a predetermined direction or a target angle. For example, the phases at the antenna ports P_{V1} to P_{V4} and P_{H1} to P_{H4} may be configured by making a gain of the antenna array 602 at the predetermined direction (or the target angle) match or approximate a predetermined value. As another example, the phases at the antenna ports P_{V1} to P_{V4} and P_{H1} to P_{H4} may be configured by making a radiation pattern of the antenna array 602 at the predetermined direction matches a predetermined pattern. In the present embodiment, process 1402B may include steps 1410B and 1420B, which will be explained with reference to FIG. 17A and FIG. 17B, respectively.

FIG. 17A is an implementation of the integrated circuit 606_1 shown in FIG. 16 employing the axial ratio compensation method 1400 shown in FIG. 14 to operate in a first polarization mode M1′ (e.g., vertical polarization mode) in accordance with some embodiments of the present disclosure. The antenna array 602 operates in the first polarization mode M1′ to turn on the ports P1, P4, P5, and P8 (i.e., the ports P_{V1}, P_{V2}, P_{V3}, and P_{V4}) configured for the first polarization (e.g., the vertical polarization), so that the buffer 1640 outputs a first RF signal CR1 which corresponds to the combination of the electrical signals E1, E4, E5 and E8. In some embodiments, the ports P2, P3, P6, and P7 (i.e., the ports P_{H1}, P_{H2}, P_{H3}, and P_{H4}) may be turned off. The antenna array 602 is configured to receive the first polarized beam from a predetermined direction PD.

In step 1410B, under the first polarization mode M1′ of FIG. 17A, beamforming of first polarization (e.g., vertical polarization) is performed according to first beamforming information PI1′ to thereby adjust the gain of the antenna array 602 in regard to the first polarization. The gain in regard to the first polarization (i.e., the gain of the first RF signal CR1) at the predetermined direction PD indicated by the first beamforming information PI1′ is adjusted to match the predetermined value (e.g., the maximum gain). The computing device 630 may combine the first aligning information obtained in step 1410A with a first direction information (not shown, similar to the first direction information PI_{BF1} of FIG. 9) to generate the first beamforming information PI1′, which is similar to the process described in FIG. 9. The first direction information is used for determining the predetermined direction PD of beamforming in the first polarization mode M1′. The first beamforming information PI1′ may be applied to the turned-on ports P1, P4, P5, and P8 (i.e., applied to the phase shifters 1621, 1624, 1625, and 1628) to control the phases at the ports P1, P4, P5, and P8 (i.e., the ports P_{V1}, P_{V2}, P_{V3}, and P_{V4}), so as to control the gain in regard to the first polarization at the predetermined direction PD. In some embodiments, the maximum gain refers to that the first RF signal CR1 having the maximum magnitude or amplitude.

In some embodiments, the gain in regard to the first polarization at the predetermined direction can be calibrated. The analyzer 620 may generate the analysis data S_{DA} according to the first RF signal CR1. The computing device 630 can controls the integrated circuit 606_1 to adjust the phase applied to the turned-on ports P1, P4, P5, and P8 (i.e., applied to the phase shifters 1621, 1624, 1625, and 1628) according to the first beamforming information PI1′ and the analysis data S_{DA}, such that the gain in regard to the first polarization at the predetermined direction can match, approximate or gradually approach the predetermined value.

FIG. 17B is an implementation of the integrated circuit 606_1 shown in FIG. 16 employing the axial ratio compensation method 1400 shown in FIG. 14 to operate in a second polarization mode M2′ (e.g., horizontal polarization mode) in accordance with some embodiments of the present disclosure. The antenna array 602 operates in the second polarization mode M2′ to turn on the ports P2, P3, P6, and P7 (i.e., the ports P_{H1}, P_{H2}, P_{H3}, and P_{H4}) configured for the second polarization (e.g., the horizontal polarization), so that the buffer 1640 outputs a second RF signal CR2 which corresponds to the combination of the electrical signals E2, E3, E6 and E7. In some embodiments, the ports P1, P4, P5, and P8 (i.e., the ports P_{V1}, P_{V2}, P_{V3}, and P_{V4}) may be turned off. The antenna array 602 is configured to receive the second polarized beam from a predetermined direction PD.

In step 1420B, under the second polarization mode M2′ of FIG. 17B, beamforming of second polarization (e.g., horizontal polarization) is performed according to second beamforming information PI2′ to thereby adjust the gain of the antenna array 602 in regard to the second polarization. The gain in regard to the second polarization (i.e., the gain of the second RF signal CR2) at the predetermined direction PD indicated by the second beamforming information PI2′ is adjusted to match the predetermined value (e.g., the maximum gain). The computing device 630 may combine the second aligning information obtained in step 1420A with a second direction information (not shown, similar to the second direction information PI_{BF2} of FIG. 10) to generate the first beamforming information PI2′, which is similar to the process described in FIG. 10. The second direction information is used for determining the predetermined direction PD of beamforming in the second polarization mode M2′. The second beamforming information PI2′ may be applied to the turned-on ports P2, P3, P6, and P7 (i.e., applied to the phase shifters 1622, 1623, 1626, and 1627) to control the phases at the ports P2, P3, P6, and P7 (i.e., the ports P_{H1}, P_{H2}, P_{H3}, and P_{H4}), so as to control the direction of gain in regard to the second polarization at the predetermined direction PD. In some embodiments, all of the V-ports and H-ports may be turned on to perform steps 1410B and 1420B concurrently.

In some embodiments, the gain in regard to the second polarization can be calibrated. The analyzer 620 may generate the analysis data S_{DA} according to the second RF signal CR2. The computing device 630 can control the integrated circuit 606_1 to adjust the phase applied to the turned-on ports P2, P3, P6, and P7 (i.e., applied to the phase shifters 1622, 1623, 1626, and 1627) according to the second beamforming information PI2′ and the analysis data S_{DA}, such that the gain in regard to the second polarization at the predetermined direction PD can match, approximate or gradually approach the predetermined value.

In the present embodiment, process 1402C may include steps 1422 to 1426. In step 1422, the analyzer 620 may measure the respective magnitudes of the first and second RF signals CR1 and CR2, and then the computing device 630 may determine whether the magnitudes of the first and second RF signals CR1 and CR2 are equal/matched. In some embodiments, all of the V-ports and H-ports may be turned on so that the magnitudes of the first and second RF signals CR1 and CR2 may be measured concurrently in step 1422. If it is determined that the magnitudes of the first and second RF signals CR1 and CR2 are equal or matched, proceed to process 1402D; otherwise, proceed to step 1424. By way of example but not limitation, in the subarray 602_1, the analyzer 620 may obtain the magnitude of the first RF signal CR1 in the first polarization mode M1′ shown in FIG. 17A, obtain the magnitude of the second RF signal CR2 in the second polarization mode M2′ shown in FIG. 17B. Then, the computing device 630 may compare the magnitudes of the first and second RF signals CR1 and CR2 to generate a comparison result. When the comparison result indicates that the magnitudes of the first and second RF signals CR1 and CR2 are equal or substantially equal, the flow proceeds to process 1402D. If the comparison result indicates that the magnitudes of the first and second RF signals CR1 and CR2 are different, the flow proceeds to step 1424.

In step 1424, the computing device 630 can control the integrated circuit to adjust the signal gains provided to the ports P1 to P8 (e.g., by adjusting the signal gains of the amplifiers 1611 to 1618), thereby controlling the magnitudes of the first and second RF signals CR1 and CR2 to be equal or substantially equal. By way of example but not limitation, in the subarray 602_1, when the magnitude of the first RF signal CR1 is less than that of the second RF signal CR2, the computing device 630 may control the integrated circuit 606_1 to increase the signal gains applied to the ports P1, P4, P5, and P8 (i.e., the ports P_{V1}, P_{V2}, P_{V3} and P_{V4}) to thereby increasing the magnitude of the first RF signal CR1. Additionally or alternatively, the computing device 630 may control the integrated circuit 606_1 to decrease the signal gains applied to the ports P2, P3, P6 and P7 (i.e., the ports P_{H1}, P_{H2}, P_{H3} and P_{H4}) to thereby decreasing the magnitude of the second RF signal CR2. When the magnitude of the second RF signal CR2 is less than that of the first RF signal CR1, the computing device 630 may control the integrated circuit 606_1 to increase the signal gains applied to the ports P2, P3, P6 and P7 (i.e., the ports P_{H1}, P_{H2}, P_{H3} and P_{H4}) to thereby increasing the magnitude of the second RF signal CR2. Additionally or alternatively, the computing device 630 may control the integrated circuit 606_1 to decrease the signal gains applied to the ports P1, P4, P5, and P8 (i.e., the ports P_{V1}, P_{V2}, P_{V3} and P_{V4}) to thereby decreasing the magnitude of first RF signal CR1. In some embodiments, the signal gains of the ports P2, P3, P6 and P7 (i.e., the ports P_{H1}, P_{H2}, P_{H3} and P_{H4}) may be adjusted by the same value in step 1424, while selectively maintaining the signal gains applied to the ports P1, P4, P5, and P8 (i.e., the ports P_{V1}, P_{V2}, P_{V3} and P_{V4}) unchanged. Alternatively, the signal strength of the ports P1, P4, P5, and P8 (i.e., the ports P_{V1}, P_{V2}, P_{V3} and P_{V4}) may be adjusted by the same value in step 1424, while selectively maintaining the signal gains applied to the ports P2, P3, P6 and P7 (i.e., the ports P_{H1}, P_{H2}, P_{H3} and P_{H4}) unchanged; however, the present disclosure is not limited thereto.

In step 1426, the magnitudes of the first and second RF signals CR1 and CR2 can be measured again to check whether the adjusted magnitudes of the first and second RF signals CR1 and CR2 become equal or substantially equal. For example, the integrated circuit 606_1 may again excite the corresponding antenna input ports in the first and second polarization modes M1′ and M2′ so that the analyzer 620 can measure the magnitudes of the first and second RF signals CR1 and CR2; then, step 1422 may be executed so that the computing device 630 can determine whether the magnitudes of the first and second RF signals CR1 and CR2 are matched. By adjusting the magnitudes of the corresponding RF signals in the first and second polarization modes M1′ and M2′ to be equal (or substantially equal), if the first and second RF signals CR1 and CR2 are orthogonal, the antenna array 602 can have good circular polarization characteristics when both of the first and second polarization modes M1′ and M2′ are activated (i.e., all antenna input ports corresponding to different polarization directions are excited).

In the present embodiment, process 1402D may include steps 1432 to 1436. In step 1432, the analyzer 620 may measure the phase difference between the first and second RF signals CR1 and CR2 corresponding to different polarization directions, and determine whether the measured phase difference equals the predetermined phase difference (e.g., 90°). The predetermined phase difference may be indicated by a phase difference information Pdiff′ stored in the computing device 630. In some embodiments, all of the V-ports and H-ports may be turned on so that the phases of the first and second RF signals CR1 and CR2 may be measured concurrently in step 1432. When it is determined that the measured phase difference equals the predetermined value, proceed to step 1440 to complete the axial ratio compensation; otherwise, proceed to step 1436. In step 1436, the computing device 630 may control the integrated circuit 606_1 to adjust the phase at the port P1 to P8 (e.g., by controlling the phase shifters 1611 to 1618), so as to accordingly adjust the phase difference to be equal to (or substantially equal to) the predetermined phase difference. The integrated circuit 606_1 may adjust the phase at the ports P2, P3, P6, and P7 (i.e., the ports P_{H1}, P_{H2}, P_{H3} and P_{H4}) by the same value, while selectively maintaining phases at the ports P1, P4, P5, and P8 (i.e., the ports P_{V1}, P_{V2}, P_{V3} and P_{V4}) unchanged. Alternatively, the integrated circuit 606_1 may adjust the signal phase of the ports P1, P4, P5, and P8 (i.e., the ports P_{V1}, P_{V2}, P_{V3} and P_{V4}) by the same value, while selectively maintaining phases at the ports P2, P3, P6, and P7 (i.e., the ports PHI, P_{H2}, P_{H3} and P_{H4}) unchanged. In step 1438, the phase difference between the first and second RF signals CR1 and CR2 can be measured again to check whether the adjusted phase difference equals or substantially equals the predetermined phase difference.

The phase difference between the first and second RF signals CR1 and CR2 may deviate from 90° at large beamforming angles. By adjusting this phase difference to 90° (or substantially) 90°, and/or controlling the magnitudes between the first and second RF signals CR1 and CR2 to be equal or substantially equal, the antenna array 602 may achieve full-angle beamforming capability and improved circular polarization characteristics. It is noted that processes 1402C and 1402D may be performed in different order. For example, process 1402D may be performed before process 1402C. In some embodiments, one of the processes 1402C and 1402D may be omitted.

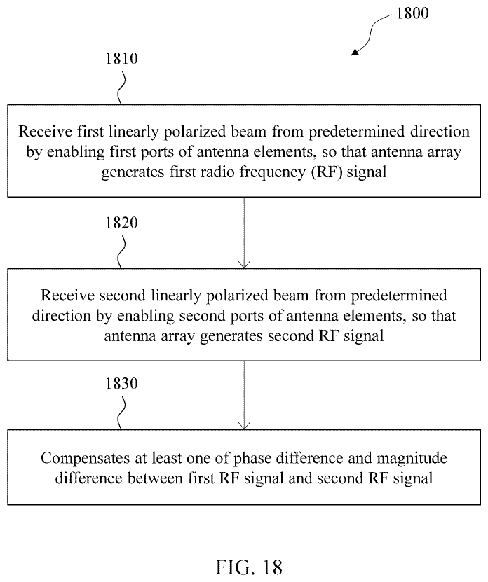

In some embodiments, the proposed axial ratio compensation scheme may be implemented using the axial ratio compensation method 1800 shown in FIG. 18. FIG. 18 illustrates an implementation of the axial ratio compensation method 1400 shown in FIG. 14 in accordance with some embodiments of the present disclosure. In the present embodiment, the axial ratio compensation method 1800 may include steps 1810, 1820, and 1830. Steps 1810 and 1820 may collaboratively represent an embodiment of steps 1402A and 1402B shown in FIG. 14; and step 1830 may represent an embodiment of steps 1402C and 1402D shown in FIG. 14. For illustrative purposes, the axial ratio compensation method 1800 is described below with reference to the antenna array 602 shown in FIG. 15. Those skilled in the art can appreciate that the axial ratio compensation method 1800 may be applied to other antenna arrays and/or antenna systems without departing from the scope of the present disclosure. Additionally, in some embodiments, other operations can be performed in the axial ratio compensation method 1800. In some embodiments, operations of the axial ratio compensation method 1800 can be performed in a different order and/or vary.

In step 1810, the antenna array 602 receives a first linearly polarized beam (e.g., the vertically polarized beam) from a predetermined direction PD by enabling the ports P_{V1} to P_{V4} of the antenna elements, so that the antenna array 602 generates a first RF signal CR1.

In step 1820, the antenna array 602 receives a second linearly polarized beam (e.g., the horizontally polarized beam) from the predetermined direction PD by enabling the ports P_{H1} to P_{H4} of the antenna elements, so that the antenna array generates a second RF signal CR2.

In step 1830, the integrated circuit 606_1 compensates at least one of a phase difference and a magnitude difference between the first RF signal CR1 and the second RF signal CR2 to compensate an axial ratio of the antenna array 602 at the predetermined direction PD.

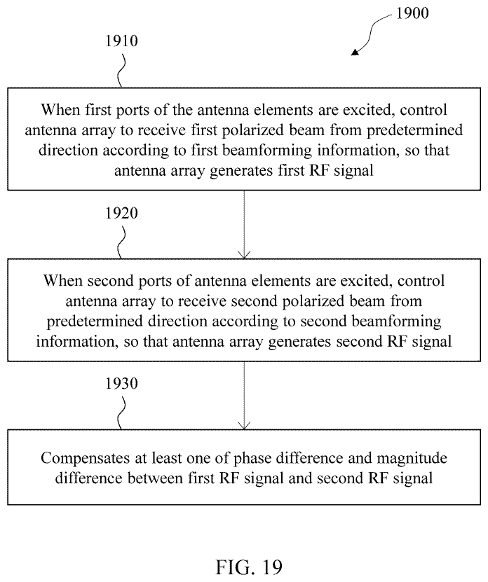

In some embodiments, the proposed axial ratio compensation scheme may be implemented using the axial ratio compensation method 1900 shown in FIG. 19. FIG. 19 illustrates an implementation of the axial ratio compensation method 1400 shown in FIG. 14 in accordance with some embodiments of the present disclosure. In the present embodiment, the axial ratio compensation method 1900 may include steps 1910, 1920, and 1930. Steps 1910 and 1920 may collaboratively represent an embodiment of steps 1402A and 1402B shown in FIG. 14; and step 1930 may represent an embodiment of steps 1402C and 1402D shown in FIG. 14. For illustrative purposes, the axial ratio compensation method 1900 is described below with reference to the antenna array 602 shown in FIG. 15. Those skilled in the art can appreciate that the axial ratio compensation method 1900 may be applied to other antenna arrays and/or antenna systems without departing from the scope of the present disclosure. Additionally, in some embodiments, other operations can be performed in the axial ratio compensation method 1900. In some embodiments, operations of the axial ratio compensation method 1900 can be performed in a different order and/or vary.

In step 1910, when respective first ports P_{V1} to P_{V4} of the antenna elements are excited, the antenna array 602 is controlled to receive the first polarized beam (e.g., the vertically polarized beam of the circularly polarized beam) from the predetermined direction PD according to the first beamforming information PI1′, so that the antenna array generates a first RF signal CR1.

In step 1920, when respective second ports P_{H1} to P_{H4} of the antenna elements are excited, the antenna array 602 is controlled to receive the second polarized beam (e.g., the horizontally polarized beam of the circularly polarized beam) from the predetermined direction PD according to second beamforming information PI2′, so that the antenna array generates a second RF signal CR2.

In step 1930, the integrated circuit 606_1 compensates at least one of a phase difference and a magnitude difference between the first RF signal CR1 and the second RF signal CR2 to compensate an axial ratio of the antenna array 602 at the predetermined direction PD.

The proposed axial ratio compensation scheme can decompose circular polarization into two linear polarization modes to thereby analyze circular polarization characteristics. In each of the linear polarization mode, the proposed axial ratio compensation scheme can perform beamforming and at least one of phase compensation and magnitude compensation. The proposed axial ratio compensation scheme not only can achieve excellent circular polarization characteristics, but also can offer high levels of intuitiveness and logical clarity.

As used herein, the terms “substantially” are used to describe and account for small variations. When used in conduction with an event or circumstance, the terms can refer to instances in which the event of circumstance occurs precisely as well as instances in which the event or circumstance occurs to a close approximation. As used herein with respect to ta given value or range, the term “substantially” generally means within +10%, +5%, +1%, or +0.5% of the given value or range. Ranges can be expressed herein as from one endpoint to another endpoint or between two endpoints. All ranges disclosed herein are inclusive of the endpoints, unless specified otherwise. In addition, when referring to numerical values or characteristics as “substantially” the same, the term can refer to the values lying within +10%, +5%, +1%, or +0.5% of an average of the values.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An axial ratio compensation method performed by an antenna system comprising an antenna array having antenna elements, the axial ratio compensation method comprising:
receiving, by the antenna array, a first linearly polarized beam from a predetermined direction by enabling respective first ports of the antenna elements, so that the antenna array generates a first radio frequency (RF) signal;
receiving, by the antenna array, a second linearly polarized beam from the predetermined direction by enabling respective second ports of the antenna elements, so that the antenna array generates a second RF signal, wherein the first linearly polarized beam and the second linearly polarized beam are substantially orthogonal; and
compensating at least one of a phase difference and a magnitude difference between the first RF signal and the second RF signal to compensate an axial ratio of the antenna array at the predetermined direction.

2. The axial ratio compensation method of claim 1, wherein each of the first ports is configured for a first polarization, and each of the second ports is configured for a second polarization orthogonal to the first polarization.

3. The axial ratio compensation method of claim 1, wherein the step of receiving, by the antenna array, the first linearly polarized beam from the predetermined direction comprises:
controlling respective first phases at the first ports according to a first beamforming information indicating the predetermined direction;
determining whether a gain of the first RF signal at the predetermined direction matches a predetermined value; and
when the gain of the first RF signal at the predetermined direction is different from the predetermined value, adjusting the first phases at the first ports to make the gain of the first RF signal at the predetermined direction equal to the predetermined value.

4. The axial ratio compensation method of claim 1, wherein the step of receiving, by the antenna array, the first polarized beam from the predetermined direction comprises:
controlling respective first phases at the first ports according to a first beamforming information (PI1′ in FIG. 15) indicating the predetermined direction;
determining whether a radiation pattern of the first ports at the predetermined direction matches a predetermined pattern; and
when the radiation pattern of the first ports at the predetermined direction is different from the predetermined pattern, adjusting the first phases at the first ports to make the radiation pattern of the first ports at the predetermined direction equal to the predetermined pattern.

5. The axial ratio compensation method of claim 1, wherein the step of compensating at least one of the phase difference and the magnitude difference between the first RF signal and the second RF signal comprises:
comparing the phase difference with a predetermined phase difference; and
when the phase difference is unequal to the predetermined phase difference, controlling the phase difference to match the predetermined phase difference.

6. The axial ratio compensation method of claim 5, wherein the step of controlling the phase difference to match the predetermined phase difference comprises:
adjusting respective first phases at the first ports by the same value.

7. The axial ratio compensation method of claim 1, wherein the step of compensating at least one of the phase difference and the magnitude difference between the first RF signal and the second RF signal comprises:
controlling a magnitude of the first RF signal and a magnitude of the second RF signal to be equal.

8. The axial ratio compensation method of claim 7, wherein the step of controlling the magnitude of the first RF signal and the magnitude of the second RF signal to be equal comprises:
adjusting respective first signal gains at the first ports by the same value.

9. The axial ratio compensation method of claim 1, wherein the step of receiving, by the antenna array, the first linearly polarized beam from the predetermined direction comprises:
making first electrical signals to be in phase, wherein the first electrical signals are generated by receiving the first linearly polarized beam through the first ports.

10. The axial ratio compensation method of claim 9, wherein the step of making the first electrical signals to be in phase comprises:
selecting one of the first electrical signals as a reference signal; and
adjusting respective first phases of the other first ports, so that superposition signals of the reference signal and each of the other first electrical signals has a maximum signal strength.

11. An axial ratio compensation method performed by an antenna system comprising an antenna array having antenna elements, the axial ratio compensation method comprising:
controlling the antenna array to receive a first polarized beam from a predetermined direction according to first beamforming information, so that the antenna array generates a first RF signal;
controlling the antenna array to receive a second polarized beam from the predetermined direction according to second beamforming information, so that the antenna array generates a second RF signal, wherein the first polarized beam and the second polarized beam have different polarization types; and
compensating at least one of a phase difference and a magnitude difference between the first RF signal and the second RF signal to compensate an axial ratio of the antenna array at the predetermined direction.

12. The axial ratio compensation method of claim 11, wherein each of the first ports is configured for a first polarization, and each of the second ports is configured for a second polarization orthogonal to the first polarization.

13. The axial ratio compensation method of claim 11, wherein the step of controlling the antenna array to receive the first polarized beam from the predetermined direction according to the first beamforming information comprises:
controlling respective first phases at the first ports according to the first beamforming information indicating the predetermined direction;
determining whether a gain of the first RF signal at the predetermined direction matches a predetermined value; and
when the gain of the first RF signal at the predetermined direction is different from the predetermined value, adjusting the first phases at the first ports to make the gain of the first RF signal at the predetermined direction equal to the predetermined value.

14. The axial ratio compensation method of claim 11, wherein the step of controlling the antenna array to receive the first polarized beam from the predetermined direction according to the first beamforming information comprises:
controlling respective first phases at the first ports according to a first beamforming information indicating the predetermined direction;
determining whether a radiation pattern of the first ports at the predetermined direction matches a predetermined pattern; and
when the radiation pattern of the first ports at the predetermined direction is different from the predetermined pattern, adjusting the first phases at the first ports to make the radiation pattern of the first ports at the predetermined direction equal to the predetermined pattern.

15. The axial ratio compensation method of claim 11, wherein the step of compensating at least one of the phase difference and the magnitude difference between the first RF signal and the second RF signal comprises:
comparing the phase difference with a predetermined phase difference; and
when the phase difference is unequal to the predetermined phase difference, controlling the phase difference to match the predetermined phase difference.

16. The axial ratio compensation method of claim 15, wherein the step of controlling the phase difference to match the predetermined phase difference comprises:
adjusting respective first phases at the first ports by the same value.

17. The axial ratio compensation method of claim 11, wherein the step of compensating at least one of the phase difference and the magnitude difference between the first RF signal and the second RF signal comprises:
controlling a magnitude of the first RF signal and a magnitude of the second RF signal to be equal.

18. The axial ratio compensation method of claim 17, wherein the step of controlling the magnitude of the first RF signal and the magnitude of the second RF signal to be equal comprises:
adjusting respective first signal gains at the first ports by the same value.

19. The axial ratio compensation method of claim 11, wherein the step of controlling the antenna array to receive the circularly polarized beam from the predetermined direction according to the first beamforming information comprises:
making first electrical signals to be in phase, wherein the first electrical signals are generated by receiving the first polarized beam through the first ports.

20. The axial ratio compensation method of claim 19, wherein the step of making the first electrical signals in phase comprises:
selecting one of the first electrical signals as a reference signal; and
adjusting respective first phases of the other first ports, so that superposition signals of the reference signal and each of the other first electrical signals has a maximum signal strength.
